(19) United States
(12) Patent Application Publication
(10) Pub. No.: US 2025/0212197 A1
(43) Pub. Date: Jun. 26, 2025

(54) COMMUNICATIONS DEVICES, NETWORK INFRASTRUCTURE EQUIPMENT AND METHODS

(71) Applicant: Sony Group Corporation, Tokyo (JP)

(72) Inventors: Shin Horng WONG, Basingstoke (GB); Basuki PRIYANTO, Basingstoke (GB); Anders BERGGREN, Basingstoke (GB)

(73) Assignee: Sony Group Corporation, Tokyo (JP)

(21) Appl. No.: 18/848,938

(22) PCT Filed: Mar. 17, 2023
(86) PCT No.: PCT/EP2023/056901

§ 371 Date: Sep. 20, 2024

(30) Foreign Application Priority Data
Mar. 31, 2022 (EP) 22166202.6

(51) Int. Cl. H04W 72/11; H04L 5/00; H04W 72/23

(52) U.S. Cl. CPC H04W 72/11; H04L 5/0055; H04L 5/0094; H04W 72/23

(57) ABSTRACT

A method for operating a communications device to receive data from a wireless network involves receiving an indication of a subset of Semi-Persistently Scheduled (SPS) resource allocations. This subset is part of multiple sets of SPS resource allocations configured through control information. The device is notified to monitor only this subset to receive data packets, rather than all SPS allocations. By monitoring fewer resources, the device improves efficiency in detecting downlink data packets. The subset to be monitored in each set is less than or equal to the total number of SPS allocations, optimizing resource monitoring for receiving the data.

### BACKGROUND

### Field of Disclosure

The present disclosure relates to communications devices, network infrastructure equipment and methods of operating a communications device and infrastructure equipment for transmitting data from a wireless communications network to a communications device. In some examples the data for communication arrives within a jitter time window so that there is some uncertainty about when data will arrive at the communications device. The present disclosure claims the Paris Convention priority of European patent application number EP22166202.6, the contents of which are incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined Long Term Evolution (LTE) and 5G architectures, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

With the development of 5G wireless communications networks advances have been made to support communications with an ever-increasing range of devices associated with a wider range of data traffic profiles and types than existing systems are optimised to support. For example, such wireless communications networks can efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those based on an evolution of 5G Radio Access Technologies (RAT) (5G advanced) and those referred to as New Radio (NR) systems/new radio access technology (RAT) systems, as well as future iterations/releases of existing systems, to support connectivity for a wide range of devices associated with different applications and different characteristic data traffic profiles and requirements.

The increasing use of different types of network infrastructure equipment and communications devices associated with different traffic profiles give rise to new challenges for efficiently handling communications in wireless communications systems that need to be addressed, particularly where there is a variation in arrival time of data to be transmitted within a jitter time window.

### SUMMARY OF THE DISCLOSURE

The present disclosure can help address or mitigate at least some of the issues discussed above. Embodiments of the present technique can provide a communications device or method, for receiving data from a wireless communications network, the communications device comprising receiver circuitry configured to receive data from the wireless communications network via the wireless access interface, transmitter circuitry configured to transmit wireless communications to the wireless communications network via the wireless access interface, and controller circuitry configured to control the receiver circuitry and the transmitter circuitry. The controller circuitry with the receiver circuitry is configured to receive an indication of a subset of Semi-Persistently Scheduled (SPS) resource allocations for each of one or more of a plurality of sets of SPS resource allocations of the wireless access interface for receiving the data as data packets. For example the sets of SPS resource allocations may have been configured by receiving control information, and the communications device may receive an indication from the wireless communications network that it only needs to monitor a subset of those SPS resource allocations. The term resource allocation identifies, for example a PDSCH allocation of communications resources of the wireless access interface for receiving a transport block or data packet on the downlink. The communications device therefore receives an indication of a subset of the SPS resource allocations of the set, which should be monitored for receiving one or more of the data packets, the subset to be monitored in each set of SPS resource allocations being less than or equal to a total number of SPS resource allocations in the set. The controller circuitry with the receiver circuitry is configured to monitor the subset of the SPS resource allocations for each of the sets to receive one or more downlink data packets which may be transmitted in one or more of the SPS resource allocations of the subset of the SPS resource allocations to receive the data.

Embodiments of the present technique can therefore receive downlink data packets more efficiently, particular where there is some jitter or uncertainty associated with a time of transmission of those data packets. As such semi persistent scheduled resource can be over provisioned/configured to allow for this jitter, with the communications device being informed in advance which of those resource allocations the wireless communications network will transmit the data packets, thereby reducing power consumption.

Embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for more efficient use of communication resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is an illustrative representation of communications resources in time and frequency for uplink and downlink channels of a time divided wireless access interface in which multiple Hybrid Automatic Repeat Request Acknowledgements (HARQ-ACK) may be multiplexed onto a single Physical Uplink Control Channel (PUCCH);

FIG. 5 is an illustrative representation of communications resources in time and frequency for uplink and downlink channels of a time divided wireless access interface in which a PUCCH Resource Indicator is used to indicate onto which PUCCH HARQ-ACKs may be multiplexed;

FIG. 6 is an illustrative representation of communications resources in time and frequency for uplink and downlink channels of a time divided wireless access interface in which an example of sub-slot based PUCCH is shown;

FIG. 7 is an illustrative representation of communications resources in time and frequency for uplink and downlink channels of a time divided wireless access interface in which multiple HARQ-ACKs for Semi-Persistent Scheduling (SPS) Physical Downlink Shared Channels (PDSCHs) are be multiplexed onto a single PUCCH per sub-slot;

FIG. 8 is an illustrative representation of a data packet size and a data packet arrival time for two data packets in accordance with example embodiments of the present disclosure;

FIG. 9 provides a representation of downlink transmission of data within one-time resource, within a plurality of potential time resources, for two consecutive data packets;

FIG. 10 is a graphical representation of downlink transmission of data within a SPS resource allocation, within a plurality of contiguous potential resource allocations, for two consecutive data packets;

FIG. 11 is a graphical representation of downlink transmission of data within a SPS resource allocation, within a plurality of non-contiguous potential resource allocations, for two consecutive data packets;

FIG. 12 is a graphical representation of a UE monitoring a subset of non-contiguous configured SPS resource allocations for two consecutive time windows according to an example embodiment;

FIG. 13 is a graphical representation of a UE monitoring a first number of SPS resource allocations, until receiving an expected number of data packets, for two consecutive time windows according to an example embodiment;

FIG. 14 is a graphical representation of five time windows, where a UE monitors different sets of SPS resource allocations in different time windows according to an example embodiment;

FIG. 15 is a graphical representation of the same five time windows, where a UE monitors different sets of SPS resources in a number of the time windows according to an example embodiment;

FIG. 16 is a graphical representation of a probability distribution function and configured SPS resource allocations for two time windows, and a measure taken to ensure a data packet can be scheduled for transmission within the time window according to an example embodiment;

FIG. 17 is a graphical representation of two time windows, where a UE monitors different numbers of SPS resource allocations determined by whether it receives a PDSCH data packet in certain resource allocations according to an example embodiment;

FIG. 18 is a graphical representation of two time windows, where a UE provides HARQ-ACK feedback to a gNB and monitors a different number of SPS resource allocations determined by whether it receives a PDSCH data packet in certain resource allocations according to an example embodiment;

FIG. 19 is a graphical representation of a time window, where a UE monitors a subset of a set of configured SPS resource allocations, and stops monitoring the subset after determining that it has received a PDSCH data packet according to an example embodiment;

FIG. 20a is a graphical representation of five time windows, where a UE monitors different sets of SPS resource allocations in different time windows according to an example embodiment; and

FIG. 20b is a graphical representation of the same five time windows, where a UE monitors different sets of SPS resources in a number of the time windows according to an example embodiment.

### DETAILED DESCRIPTION OF THE EMBODIMENTS

### Long Term Evolution Advanced Radio Access Technology (4G)

Example embodiments relate to communicating data which has an uncertain arrival time via a wireless access interface. Examples of wireless communications networks will be briefly described below to illustrate example embodiments.

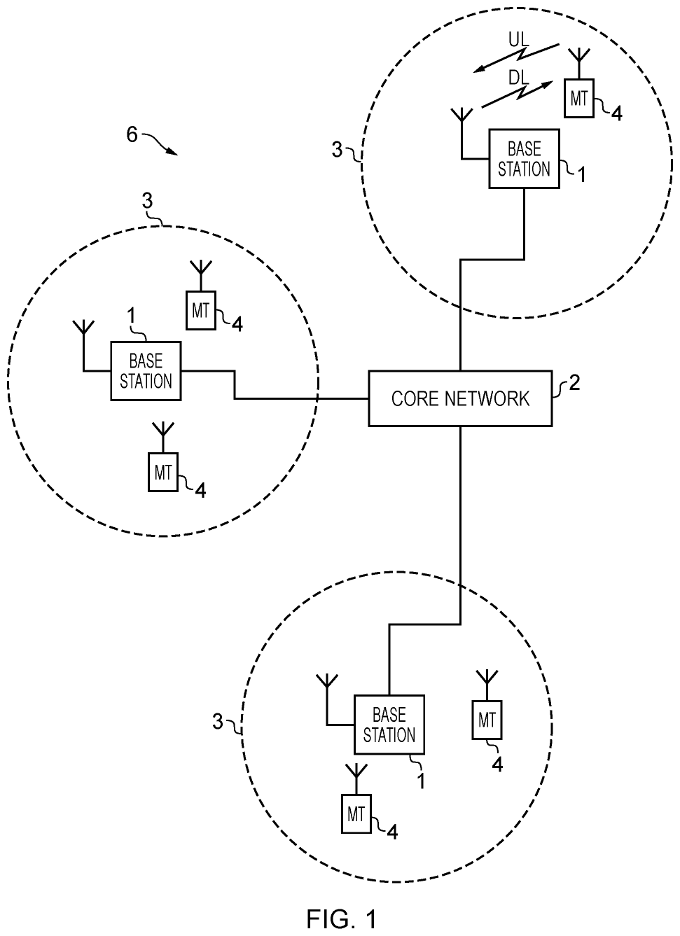

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology NR (5G)

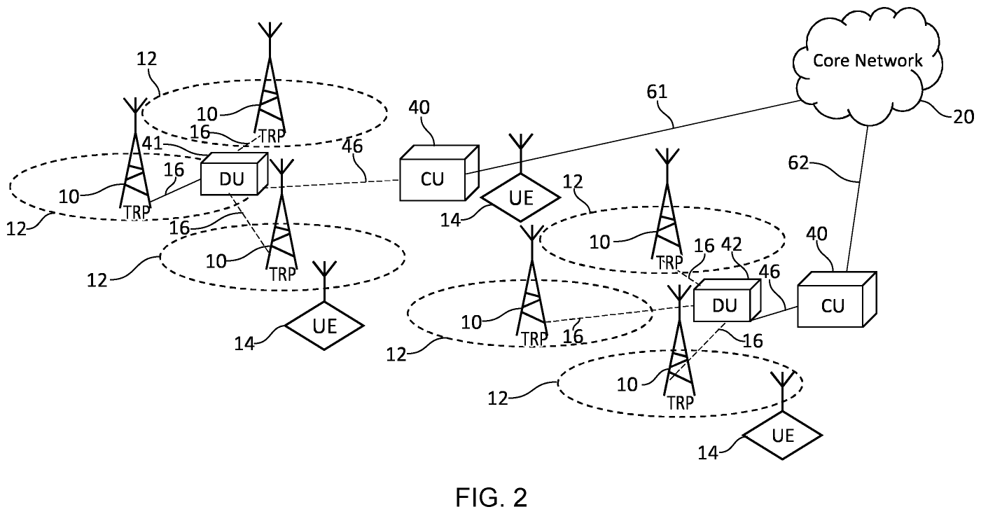

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network or gNB of an NR network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

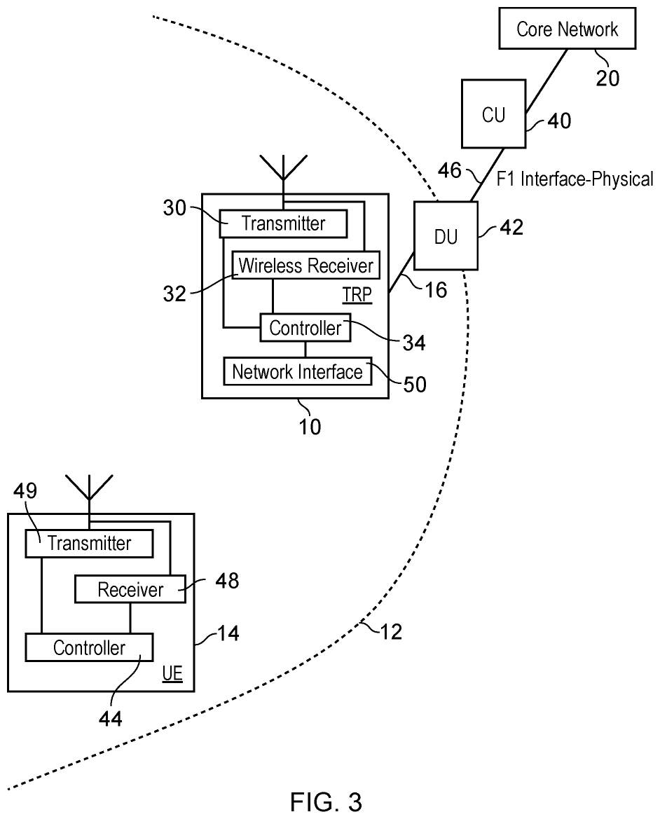

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Dynamic Grant PDSCH

Embodiments of the disclosure relate to a communications device and methods of operating a communications device (UE) in a wireless communications network for handling downlink reception of data in respect of downlink transmissions in physical downlink shared channel (PDSCH) resources of a wireless access interface provided by the wireless communications network. In a Dynamic Grant PDSCH (DG-PDSCH), the PDSCH resource is dynamically indicated by the gNB using a DL Grant carried by Downlink Control Information (DCI) in a Physical Downlink Control Channel (PDCCH).

A PDSCH is transmitted using HARQ transmission, where for a PDSCH ending in slot n, the corresponding Physical Uplink Control Channel (PUCCH) carrying the HARQ-ACK is transmitted in slot n+K₁. Here, in Dynamic Grant PDSCH, the value of K₁ is indicated in the field “PDSCH-to-HARQ_feedback timing indicator” of the DL Grant (carried by DCI Format 1_0, DCI Format 1_1 or DCI Format 1_2). Multiple (different) PDSCHs can point to the same slot for transmission of their respective HARQ-ACKs, and these HARQ-ACKs (in the same slot) are multiplexed into a single PUCCH. Hence, a PUCCH can contain multiple HARQ-ACKs for multiple PDSCHs.

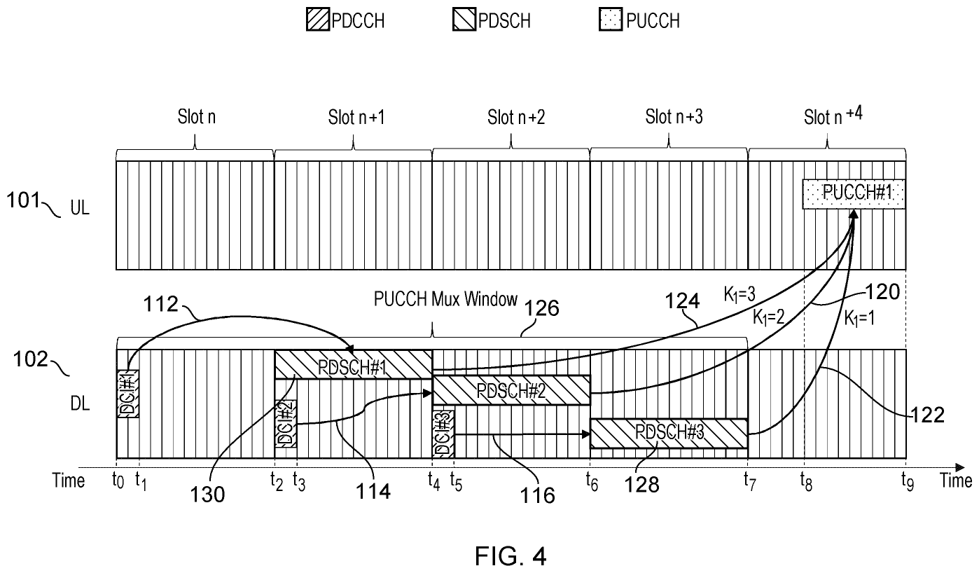

An example of this is shown in FIG. 4, where three DL Grants are transmitted to the UE via DCI #1, DCI #2 and DCI #3 in slot n, n+1 and n+2 respectively on a DL of a wireless access interface 102. DCI #1, DCI #2 and DCI #3 schedule PDSCH #1, PDSCH #2 and PDSCH #3 respectively as represented by arrow 112, 114, 116. DCI #1, DCI #2 and DCI #3 further indicate K₁=3, K₁=2 and K₁=1 respectively, which determine the uplink channel resource of the UL channel 101, as represented by arrows 120, 122, 124. Since the K₁ values indicate that the HARQ-ACK feedback for PDSCH #1, PDSCH #2 and PDSCH #3 are all to be transmitted in slot n+4, the UE multiplexes all of these HARQ-ACKs into a single PUCCH, i.e. PUCCH #1. The PUCCH Multiplexing Window is a time window where PDSCHs can be multiplexed into that single PUCCH, and the size of the PUCCH multiplexing window depends on the range of K₁ values. In the example in FIG. 4, the PUCCH Multiplexing Window is from Slot n to Slot n+3 (i.e. between time t₀ and time t₇), which means the max K₁ value is 4 slots.

In Rel-15, only one PUCCH per slot is allowed to carry HARQ-ACKs for the same UE, even if the different PUCCHs do not overlap in time they are considered to be in collision. The PUCCH resource is indicated in the “PUCCH Resource Indicator” (PRI) field in the DL Grant. Each DL Grant may indicate a different PUCCH resource, but the UE will follow the PRI indicated in the last PDSCH in the PUCCH Multiplexing Window since the UE only knows the total number of HARQ-ACK bits after the last PDSCH is received.

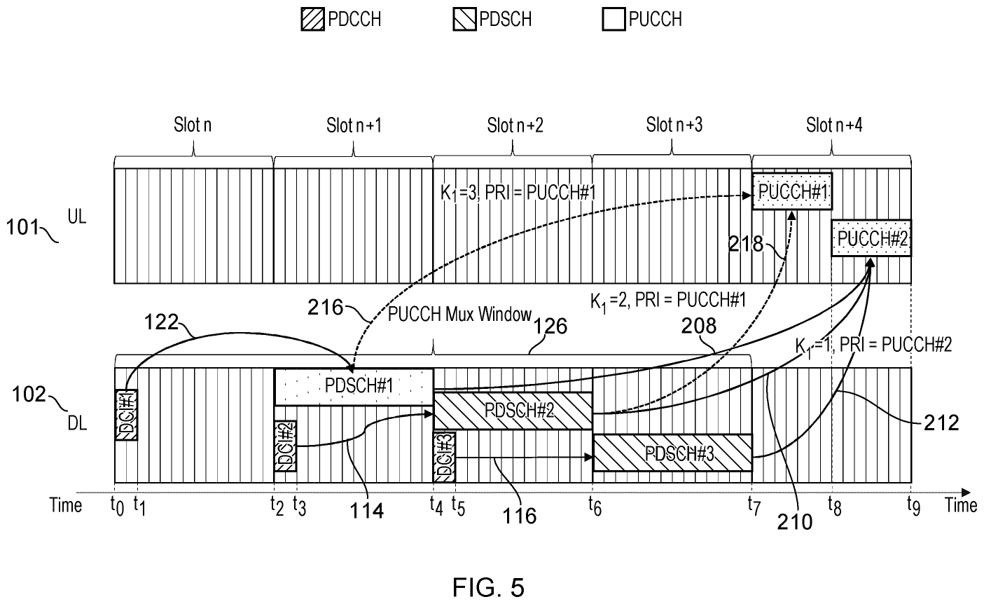

An example of this is shown in FIG. 5, which corresponds to the example of FIG. 4, where DCI #1 and DCI #2 indicate PUCCH #1 for the HARQ-ACKs corresponding to PDSCH #1 and PDSCH #2, but DCI #3 indicates PUCCH #2 for the HARQ-ACK corresponding to PDSCH #3, as represented by arrows 212, 216, 218. Here, PUCCH #1 and PUCCH #2 do not overlap in time. Since DCI #3 schedules the last PDSCH, i.e. PDSCH #3, in the Multiplexing Window, the UE will use PUCCH #2 to carry the HARQ-ACKs for PDSCH #1, PDSCH #2 and PDSCH #3 as represented by arrows 208, 210 and 212 respectively. It should be noted here that a PUCCH carrying other UCI such as SR (Scheduling Request) can be transmitted separately to a PUCCH carrying HARQ-ACKs within the same slot if they do not overlap in time.

In Rel-16, sub-slot PUCCH is introduced for carrying HARQ-ACKs for PDSCHs. For example, these could be carrying Ultra Reliable Low-Latency Communications, URLLC. Sub-slot based PUCCHs allow more than one PUCCH carrying HARQ-ACKs to be transmitted within a slot. This gives more opportunity for PUCCHs carrying HARQ-ACKs for PDSCHs to be transmitted within a slot, thereby reducing latency for HARQ-ACK feedback. In a sub-slot based PUCCH, the granularity of the K₁ parameter (i.e. the time difference between the end of a PDSCH and the start of its corresponding PUCCH) is in units of sub-slots instead of units of slots, where the sub-slot size can be either two symbols or seven symbols.

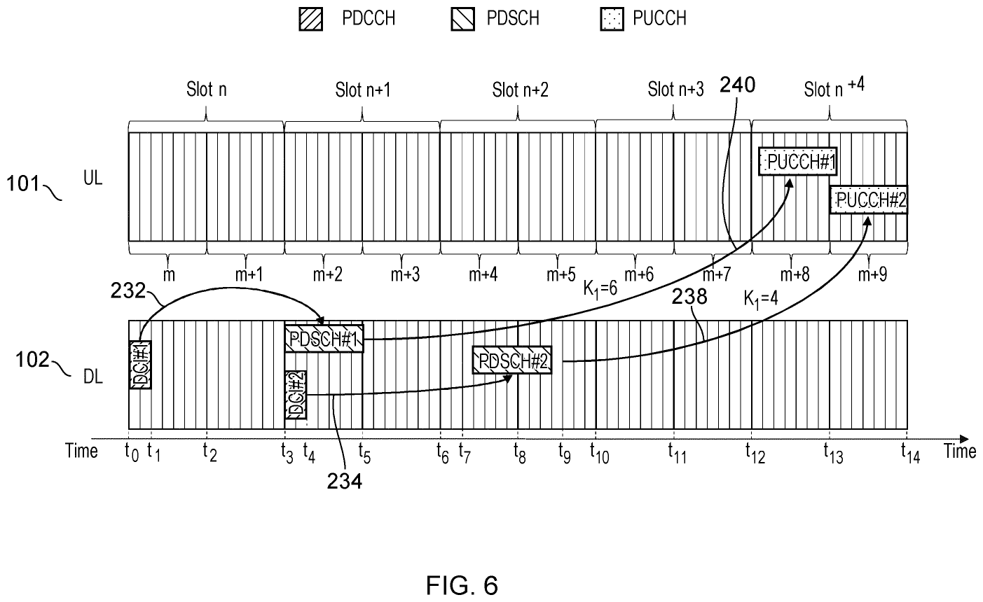

An example of this is shown in FIG. 6, which corresponds to FIGS. 4 and 5, where the sub-slot size equals seven symbols (i.e. half a slot) and the sub-slots are labelled as m, m+1, m+2, etc. PDSCH #1 is transmitted in slot n+1 but for sub-slot based HARQ-ACK PUCCH, it is considered to be transmitted in sub-slot m+2 and here K₁=6 which means that the corresponding HARQ-ACK is in sub-slot m+2+K₁=m+8. PDSCH #2 is transmitted in slot n+2 but occupies sub-slots m+4 and m+5. The reference for K₁ is relative to the sub-slot where the PDSCH ends, and in this case PDSCH #2 ends in sub-slot m+5. The DL Grant in DCI #2 that schedules PDSCH #2 indicates K₁=4, which schedules a PUCCH for its HARQ-ACK at sub-slot m+5+K₁=sub-slot m+9.

### Semi-Persistent Scheduling (SPS)

As is well understood by those skilled in the art, a gNB uses a PDSCH for downlink data transmission to a UE. The PDSCH resources used for the transmission of the PDSCH can be scheduled by a gNB either dynamically, or through the allocation of Semi-Persistent Scheduling (SPS) resources.

Similarly, to the use of Configured Grants (CGs) in the uplink, the use of SPS in the downlink reduces latency, particularly for regular and periodic traffic. The gNB is required to explicitly activate and deactivate SPS resources when it determines they may be required. These SPS resources are typically configured via Radio Resource Control (RRC) signalling, and occur periodically where each SPS PDSCH occasion has a pre-configured and fixed duration. This allows the gNB to schedule traffic that has a known periodicity and packet size. The gNB may or may not transmit any PDSCH in any given SPS PDSCH occasion, and so the UE is required to monitor each SPS PDSCH occasion for a potential PDSCH transmission.

In Rel-15 the UE can only be configured with one SPS PDSCH and this SPS PDSCH is activated using an activation DCI (Format 1_0 or 1_1) with the Cyclic Redundancy Code (CRC) scrambled with a Configured Scheduling Radio Network Temporary Identifier (CS-RNTI). Once an SPS PDSCH is activated, the UE will monitor for a potential PDSCH in each SPS PDSCH occasion of the SPS PDSCH configuration without the need for any DL Grant until the SPS PDSCH is deactivated. Deactivation of the SPS PDSCH is indicated via a deactivation DCI scrambled with CS-RNTI. The UE provides a HARQ-ACK feedback for the deactivation DCI, but no HARQ-ACK feedback is provided for an activation DCI.

Similar to DG-PDSCH, the slot containing the PUCCH resource for HARQ-ACK corresponding to SPS PDSCH is indicated using the K₁ value in the field “PDSCH-to-HARQ_feedback timing indicator” of the activation DCI. Since a dynamic grant is not used for SPS PDSCH, this K₁ value is applied for every SPS PDSCH occasion, and can only be updated after it has been deactivated and re-activated using another activation DCI with a different K₁ value.

Since there is only one SPS PDSCH, PUCCH Format 0 or 1 is used to carry the HARQ-ACK feedback. If the PUCCH collides with a PUCCH carrying HARQ-ACK feedback for a DG-PDSCH, the HARQ-ACK for SPS PDSCH is multiplexed into the PUCCH corresponding to the DG-PDSCH.

In Rel-16 the UE can be configured with up to eight SPS PDSCHs, where each SPS PDSCH has an SPS Configuration Index that is RRC configured. Each SPS PDSCH is individually activated using a DCI (Format 1_0, 1_1, and 1_2) with the CRC scrambled with CS-RNTI, where the DCI indicates the SPS Configuration Index of the SPS PDSCH to be activated. However, multiple SPS PDSCHs can be deactivated using a single deactivation DCI. Similar to Rel-15, the UE provides a HARQ-ACK feedback for the deactivation DCI, but does not provide one for the activation DCI.

The slot or sub-slot containing the PUCCH resource for HARQ-ACK feedback corresponding to an SPS PDSCH occasion is determined using the K₁ value indicated in the activation DCI. Since each SPS PDSCH configuration is individually activated, different SPS PDSCH can be indicated with different K₁ values.

Since different K₁ values can be used for different SPS PDSCH configurations, it is possible that the HARQ-ACK for multiple SPS PDSCHs point to the same slot or sub-slot, and in such a scenario, these HARQ-ACKs are multiplexed into a single PUCCH. For multiple SPS PDSCH configurations, PUCCH Format 2, 3, and 4 (in addition to PUCCH Format 0 and 1) can be used to carry multiple HARQ-ACKs for SPS PDSCH. Here, the HARQ-ACKs in the PUCCH are sorted in ascending order according to the DL slot for each of the SPS PDSCH Configuration Indices, and then sorted in ascending order of SPS PDSCH Configuration Index. It should be noted here that since typically the K₁ value is fixed per SPS PDSCH then it is unlikely to have two or more SPS PDSCH with the same index being multiplexed into a PUCCH.

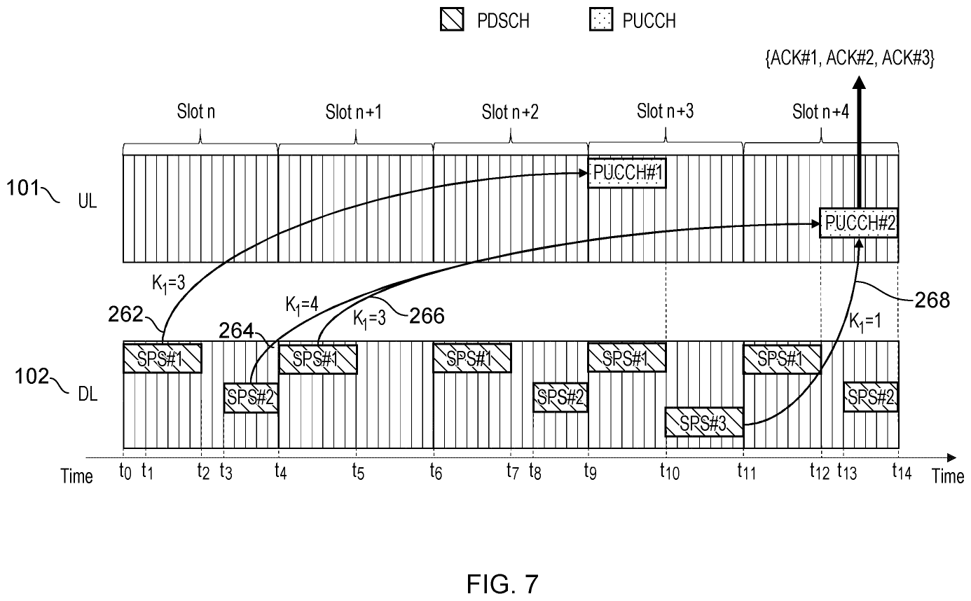

An example of this is shown in FIG. 7, where a UE is configured with three SPS PDSCHs labelled as SPS #1, SPS #2 and SPS #3 with different periodicities that are RRC configured with SPS Configuration Index 1, 2 and 3 respectively. SPS #1, SPS #2 and SPS #3 are activated with K₁=3, K₁=4 and K₁=1 respectively. These K₁ values result in the PUCCH for HARQ-ACK feedback corresponding to SPS #2 in Slot n, SPS #1 in Slot n+1 and SPS #3 in Slot n+3 being in the same slot, i.e. carried by PUCCH #2 in Slot n+4, as represented by arrows 262, 264, 266, 268. PUCCH #2 therefore provides 3 HARQ-ACKs labelled as {ACK #1, ACK #2, ACK #3} for SPS #1, SPS #2 and SPS #3 respectively according to their SPS PDSCH Configuration Indices (it can be seen that, in this example, there is only one unique SPS PDSCH per DL slot that has HARQ-ACK multiplexed into PUCCH #2).

In Rel-16, when the PUCCH for an SPS PDSCH collides with the PUCCH for a DG-PDSCH, their HARQ-ACKs are multiplexed, where the SPS PDSCH HARQ-ACKs are appended after those for DG-PDSCH, if they have the same priority. Otherwise, one of the PUCCHs is prioritised.

### Jitter

One of the problems with carrying traffic produced by a source is to manage an arrival time of data packets, which varies within a jitter window. For example, extended Reality (XR) and refer to various types of augmented, virtual, and mixed environments, where human-to-machine and human-to-human communications are performed with the assistance of handheld and wearable end user devices (UEs). XR and Cloud Gaming are two applications that are considered important for NR Rel-18 and beyond (also known as 5G Advanced). XR and Cloud Gaming are two applications that may require relatively high data-rate and low-latency requirements. A significant delay/latency in a transmission of large data packet mat reduce the UE experience in XR. Hence, a Rel-18 Study Item on eXtended Reality (XR) has been approved in 3GPP [2] to study potential enhancements to the legacy 5G system for support of XR traffic.

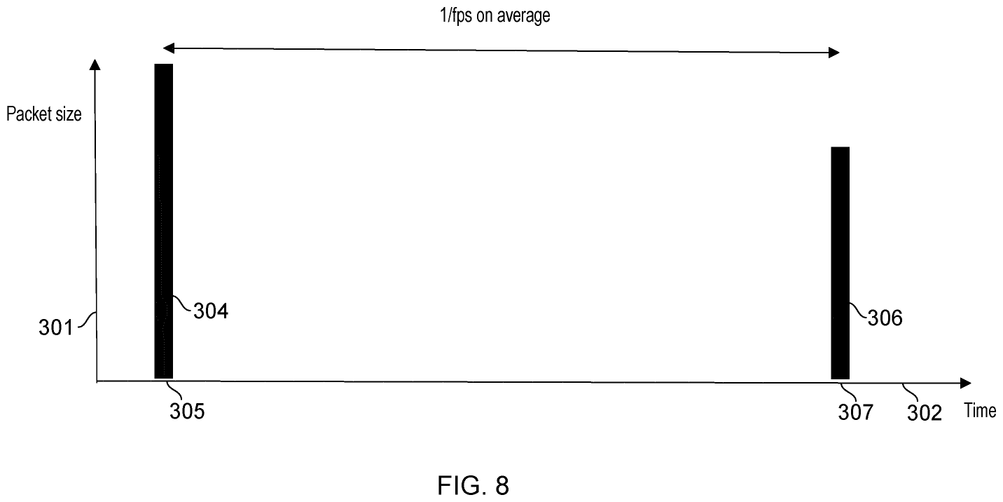

XR traffic is rich in video, especially in the downlink, with a typical frame rate of 60 Hz [3], which leads to a data transmission with non-integer periodicity in NR, i.e. a periodicity of data transmission frames is not an integer number of subframes and, in this example, the periodicity is 16.67 ms. Due to varying frame encoding delay and network transfer time, arrival of a packet to be transmitted to the UE at the gNB may experience random jitter. An example of frame rate and jitter of DL traffic is illustrated in FIG. 8. FIG. 8 is a graphical representation of a packet size (represented on a vertical axis 301) shown with respect to a time of arrival of those packets (shown as a horizontal axis 302). In FIG. 8 a first packet 304 arrives at a first time 305, and a second packet 306 arrives at a second time 307. Both a packet size of the first packet 304 and a packet size of the second packet 306, and corresponding packet arrival times 305 and 307, may experience jitter, whereby, as an example, the effect of the jitter on the packet size or the packet arrival time may be modelled by a probability distribution, such as a normal or Gaussian distribution, a Poisson distribution or another such suitable distribution. The non-integer and jitter characteristics of XR traffic is known as quasi-periodic traffic. In the legacy 5G system, traffic with known periodicity and packet size, e.g. voice, is typically supported using Semi-Persistent Scheduling (SPS) PDSCH and Configured Grant PUSCH (CG-PUSCH). In legacy systems SPS and CG-PUSCH assume that a Transport Block Size (TBS) of the PDSCH and PUSCH of the traffic are the same in every period. However, in XR traffic, the payload of a quasi-periodic traffic may not be the same but varies within a range, and may be governed by a probability distribution as detailed above. Recognising the limitations in legacy SPS and CG-PUSCH, one of the objectives of the Study Item is to investigate potential enhancements to the legacy SPS and CG-PUSCH features in 5G [2].

### Jitter Time of Packets

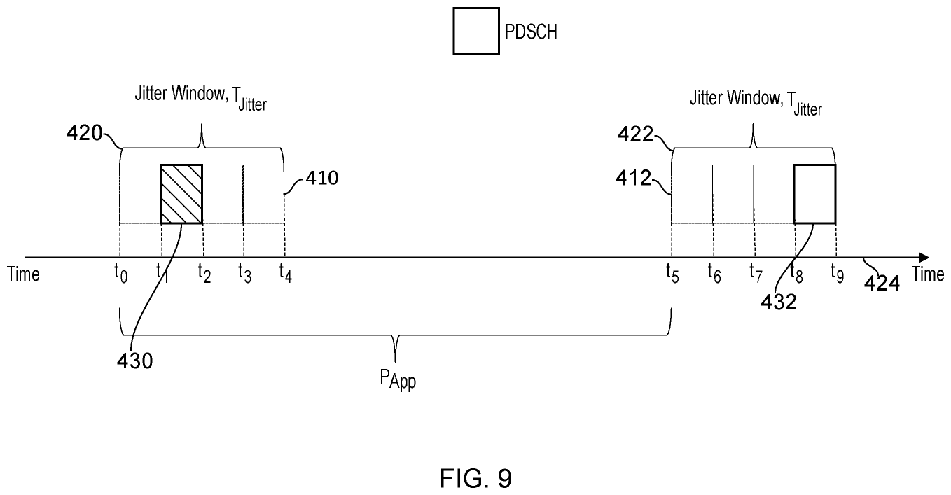

Although a data packet arrival time of data packets for some services, for example XR services, may be periodic, the actual arrival time of the data packet may experience jitter causing it to arrive randomly within a jitter time window, T_{Jitter}. FIG. 9 provides a representation illustrating a downlink, DL, transmission of data to support for example an XR service. In FIG. 9, an XR application communicates data over a certain bandwidth generating data packets as periodic traffic with a periodicity of P_{App}. FIG. 9 provides a representation of a transmission of data on PDSCH resources scheduled as a SPS resource, corresponding to time resources represented by two sets of four boxes 410, 412 within two example jitter time windows T_{Jitter} 420, 422, which are shown in a simplified form with respect to that of FIGS. 4 to 7 with respect to time 424. However, this traffic experiences jitter and so the actual packet arrival occurs at a time within a time window T_{Jitter}. In this example, the first jitter time window starts at time to where the packet can arrive within this time window between t₀ to t₄ and here the packet arrives at time t₁, 430. The next time window begins a time P_{App} later, starting at time t₅, and here once again the packet can arrive at any time within the jitter time window between t₅ to t₉. In the second instance, the packet arrives at time t₈, which is towards the end of the jitter time window T_{Jitter} as shown in a shaded box 432.

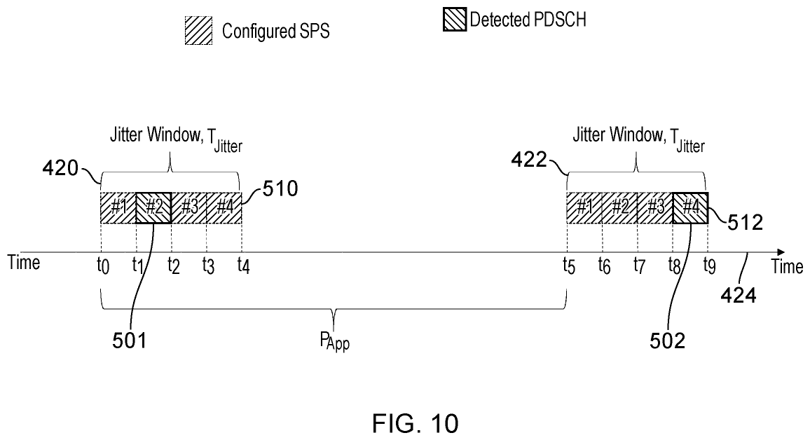

SPS configuration provides PDSCH resources to the UE with a deterministic periodicity, which can be from 1 to 640 slots. It may be recognised that such deterministic periodicity configuration is not suitable for traffic experiencing jitter. In one example, in order to account for jitter, and to have the data reliably received by the UE, multiple SPS configurations are used, where each SPS configuration may be activated with a different starting offset, i.e. different K₀, as indicated in a DCI field “Time Domain Resource Assignment” (TDRA). That is, the SPS resource can be over-configured to support jittering. In the example in FIG. 9, the UE can be configured with two sets of four SPS PDSCH resource allocations 410, 412, such that these four SPS resource allocations fall within the jitter time window 420, 422 and each has a periodicity of P_{APP}. A further example is shown in FIG. 10, and for the sake of conciseness, only differences between FIGS. 9 and 10 will be described. In FIG. 10, two sets of four SPS resource allocations labelled as #1, #2, #3 and #4 with periodicity P_{App}, are configured for a UE and represented by four boxes 510, 512 in the two time windows 420 and 422 as shown. The four resource allocations have different time offsets, such that the resources cover the jitter time window. In the example of FIG. 10 and in a first time window 420, resource allocation SPS #1 has no offset, resource allocation SPS #2 is offset with respect to time, such that it begins at time t₁, and resource allocation SPS #3 is offset with twice the offset in comparison to SPS #2, such that SPS #3 begins at time t₂. Likewise, resource allocation SPS #4 is offset with three times the offset of SPS #2, such that SPS #4 begins at time t₃. The same can be seen with the respective times of the second time window 422, but with SPS #1 beginning at t₅ for this second time window. In contrast to FIG. 10, representing the SPS resource allocations, FIG. 9 represented the time resources to be used to transmit/receive the data packet. Hence, by configuring multiple SPS resources, the UE may therefore be provided with PDSCH resources whenever the packet data arrives within the jitter time window. As will be appreciated from a consideration of FIGS. 9 and 10, the transmission of the data in the examples shown in FIGS. 9 and 10 occurs in SPS #2 in the first jitter time window 420, and in the SPS #4 in the second jitter time window 422. However, this is not a limitation of the SPS resource in which the PDSCH may be transmitted, and the data may be transmitted in any of the resources, as governed by the probability distribution. As will be appreciated, the UE must monitor all of the PDSCH resource allocations, until at least one data packet is received, although the data packet is only transmitted in one of these resource allocations.

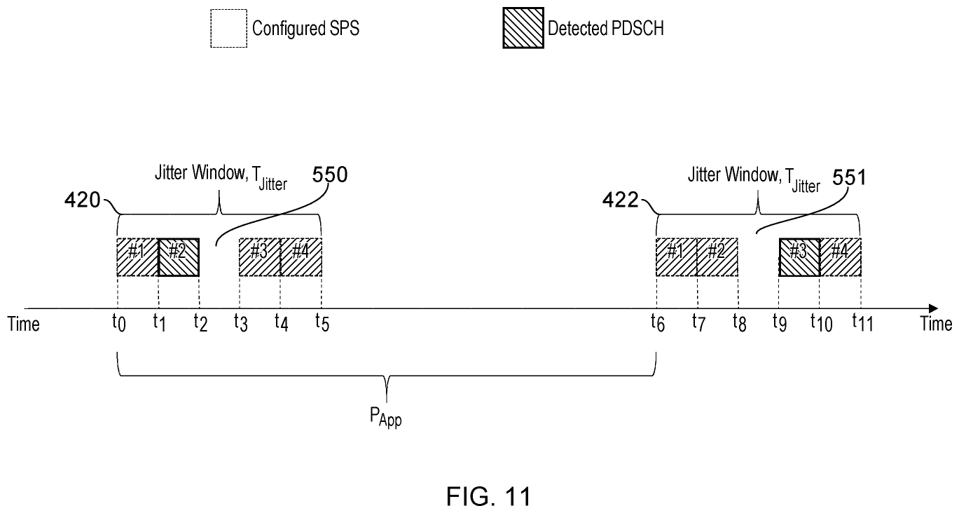

It should also be appreciated that the SPS resources configured within a jitter time window, T_{Jitter}, do not need to be adjacent to each other and there can be gaps between two SPS instances. An example is shown in FIG. 11, where four SPS instances, SPS #1, SPS #2, SPS #3 and SPS #4, are configured to handle jitter and here we have a gap between SPS #2 and SPS #3, 550 and 551 respectively within jitter time windows 420 and 422. These examples have exhibited over-configuration of SPS resources, that is, an allocation of more SPS resources than are required to receive the data, due to uncertainty as to when the data packet will be transmitted by the gNB. It should also be appreciated that over-configuration of SPS resources is not limited to only traffic types with jitter but can also be used for traffic types that do not have a periodicity that matches those that are configurable by RRC. Since the UE needs to monitor all SPS regardless of whether they contain any actual data transmitted over the PDSCH or not, over-configuration of SPS to serve reception of a single data packet consumes unnecessary UE power. In one embodiment, SPS resources are provided that may be suitable for reception of quasi-periodic traffic, whilst minimising additional UE monitoring.

Embodiments of the present technique can provide a communications device or method, for receiving data from a wireless communications network, the communications device comprising receiver circuitry, configured to receive data from the wireless communications network via the wireless access interface, transmitter circuitry, configured to transmit wireless communications to the wireless communications network via the wireless access interface, and controller circuitry configured to control the receiver circuitry and the transmitter circuitry. The controller circuitry with the receiver circuitry is configured to receive an indication of a subset of SPS resource allocations for each of one or more of a plurality of sets of SPS resource allocations of the wireless access interface for receiving the data as data packets. For example, the sets of SPS resource allocations may have been configured by receiving control information, and the communication device may receive an indication from the wireless communication network that is only needs to monitor a subset of those SPS resource allocations. The term resource allocation identifies, for example a PDSCH allocation of resources for receiving a transport block or data packet. The communications device therefore receives an indication of a subset of the SPS resource allocations of the set, which should be monitored for receiving one or more of the data packets, the subset to be monitored in each set of SPS resource allocations being less than or equal to a total number of SPS resource allocations in the set. The controller circuitry with the receiver circuitry is configured to monitor the subset of the SPS resource allocations for each of the sets to receive one or more downlink data packets which may be transmitted in one or more of the SPS resource allocations of the subset of the SPS resource allocations to receive the data.

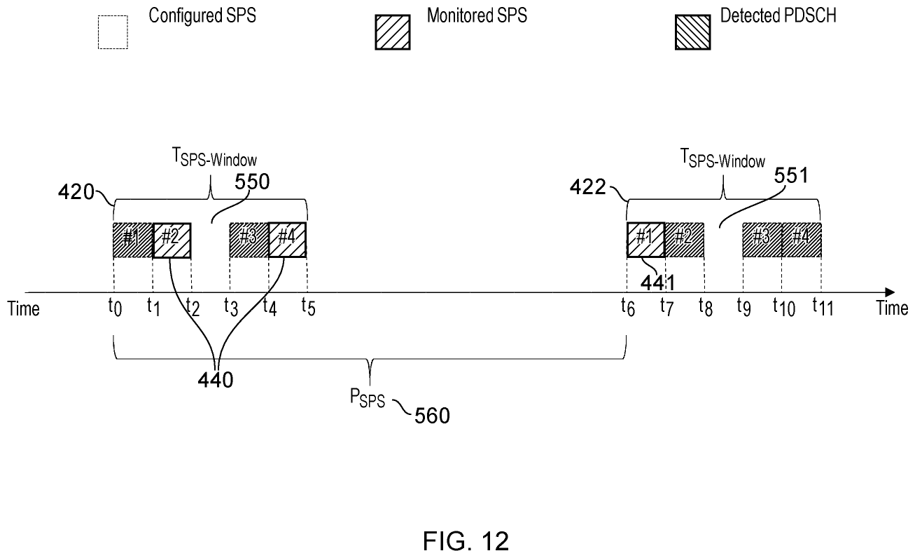

As will be set out and explained below with reference to FIGS. 12 to 20b, a method and an apparatus are disclosed which addresses these identified problems. In particular, the UE can monitor a subset of configured SPS resource allocations in a configured set of SPS resource allocations, for instance monitoring only M_{SPS} elements out of N_{SPS} elements, where M_{SPS}≤N_{SPS}, and both M_{SPS} and N_{SPS} represent numbers. In this way, a corresponding subset, M, of a larger set, N, is monitored, where M is the subset of M_{SPS} monitored resource allocations, and a larger set of N_{SPS} configured resource allocations, including some resources that the UE is configured to monitor, and some it is configured not to monitor. As will be appreciated, values of M_{SPS}, N_{SPS}, and the corresponding sets of resources can vary from one period to another. This recognises that in quasi-static periodic traffic, it is typical for only one of the configured SPS resource allocations in a set, for instance the set N, to contain a PDSCH data packet for the UE as shown in FIGS. 10 and 11. However, this is not to be understood as a limitation of example embodiments to the transmission in a period of only one PDSCH data packet, and it would be apparent to one skilled in the art that this disclosure can be readily adapted to include a plurality of PDSCH data packets, designated by the quantity M_{PDSCH} indicating the number of PDSCH data packets transmitted in a single period. Furthermore, in addition to the number of SPS resource allocations to be monitored, which is indicated to the communications device by the transmitted quantity M_{PDSCH}, and the subset of SPS communications resources, a pattern may also be transmitted to the communications device. This pattern may provide greater detail as to which SPS resource allocations should be monitored by the communications device. For instance, the pattern may indicate a starting offset, such that the first monitored SPS resource allocation of the subset equipped with the pattern is not the same first SPS resource allocation of the set of SPS resource allocations. In a further example, the pattern might provide gaps within, or following, the one or more monitored SPS resource allocations, the gaps being formed of SPS resource allocations that the communications device should not monitor. Alternatively, the gaps may be formed of communications resources that the communications device is not scheduled to monitor, either semi-permanently or in other ways. In other embodiments, the presence of the pattern in an indication to the communications device is implied by an indication of the SPS resource allocations that should be monitored by the communications device e.g. by indicating to the communications device that it should monitor SPS resource allocations numbered 2, 3, 6, 7, and 9 in a set of SPS resource allocations numbered from 1 to 10, a pattern may be implied of a starting offset, as well as gaps between and following SPS resource allocations that the communications device should monitor.

According to example embodiments a UE receives an indication from a gNB of which of the SPS resource allocations it should monitor. The SPS set, for example SPS set N, contains SPS resource allocations within a time window T_{SPS-Window}, where this time window can be used to cover a jitter time window T_{Jitter}, as in FIGS. 9-11, which may be for example for a specific XR traffic. This time window has a periodicity of P_{SPS}, 560, which begins at to and ends at to. An example of this periodicity is shown in FIG. 12, which is also illustrated in example embodiments. As will be seen with respect to this example, in both time windows the value of N_{SPS}=4. In the first time window, 420, the value of M_{SPS}=2, and SPS #2 and SPS #4 are monitored, as indicated by 440, and SPS #1 and SPS #3 are not monitored. In contrast to this, in the second time window, 422, the value of M_{SPS}=1, as only SPS #1 is monitored, as again indicated by 441, and SPS #2, SPS #3, and SPS #4 are not monitored. The SPS resource allocations SPS #1, SPS #2, SPS #3, and SPS #4 have a same periodicity P_{SPS} but are activated with different starting offsets (namely, no offset, a standard offset O₁ equal to t₁-t₀, an offset equal to two times O, and an offset equal to three times O respectively), so that the set of resources N covers the time window T_{SPS-Window}.

### Subset of SPS, M_{SPS}

Example embodiments described in this section can provide methods to determine the M_{SPS} out of N_{SPS} configured SPS in the SPS set. In the following description, M_{SPS} designates the number of SPS resource allocations monitored by the UE, and M_{PDSCH} designates the number of PDSCH data packets to be received in a time window.

### First M_{SPS} SPS

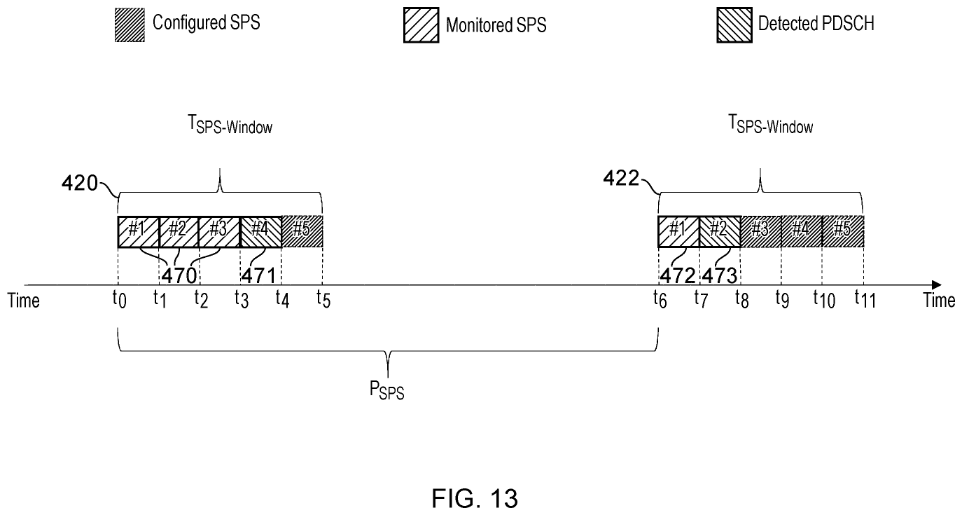

In an example embodiment, a UE is configured to monitor a subset of SPS resource allocations, and to stop monitoring once it has detected an indicated number of transmissions in the monitored SPS resource allocations, i.e. the UE monitors the first SPS resource allocation, and continues to monitor SPS resource allocations until the UE detects the first M_{PDSCH} data packets in the SPS set, when it stops monitoring the remaining SPS resource allocations. An example of this embodiment with M_{PDSCH}=1 and N_{SPS}=5 is shown in FIG. 13. In the time window 420 between time t₀ to t₅, the PDSCH data packet is transmitted in SPS #4 and as per this embodiment, the UE monitors the first three SPS resource allocations, 470, i.e. SPS #1, SPS #2, SPS #3 without detecting a PDSCH data packet, and monitors the fourth SPS resource allocation, SPS #4, 471, and stops after SPS #4 after detecting the PDSCH data packet in SPS #4. Similarly, in the second time window, 422, between time t₀ to t₁₁, the UE monitors SPS #1 unsuccessfully, 472, and monitors SPS #2 successfully, 473, since it detects a PDSCH data packet in SPS #2. As would be apparent, this is not limited to a single PDSCH data packet, but stopping after detecting a single packet is a result of the value of M_{PDSCH} being one. Therefore, after detecting M_{PDSCH}=1 PDSCH data packet and having monitored a total of M_{SPS} resource allocations, the UE stops monitoring the rest of the SPS resource allocations in the SPS set N and the remaining configured SPS resource allocations, SPS #3, SPS #4, and SPS #5 are not monitored, resulting in a reduction of UE power consumption to perform monitoring. In this embodiment, if the data packets of two different time windows are transmitted in the resource allocation of the same number i.e. both SPS #1, both SPS #2 etc., then the value of M_{SPS} will be the same for the two time windows. Conversely, if the data packet is transmitted in resource allocations of different numbers, then the value of M_{SPS} will vary between time windows. In this example embodiment, the number of monitored SPS, i.e. M_{SPS}, can be different in different period since it depends on when the M_{PDSCH} PDSCH data packets are detected. Using the example in FIG. 10, M_{SPS}=4 in the first time window 420, and M_{SPS}=2 in the second time window 422. In this embodiment, if the PDSCH data packet is transmitted in the last SPS resource monitored by the UE, the UE monitors all the SPS resource allocations in the SPS set. However, since the arrival of the PDSCH data packet within the jitter time window covered by T_{SPS-Window} is governed by a relevant probability distribution, on average a UE will monitor fewer SPS resource allocations than compared to monitoring all SPS resource allocations, regardless of whether the M_{PDSCH} PDSCH data packets have already been received. The values for M_{PDSCH} can be RRC configured or indicated in the activation DCI.

### Different SPS Monitoring Rate

In another example embodiment, the SPS set consists of one or more SPS subsets, where the different SPS subsets have different monitoring rates. That is, some SPS resource allocations corresponding to an SPS subset in an SPS set are monitored more often (that is, with a lower periodicity between instances where the UE monitors the particular SPS subset) than other SPS resource allocations in the same SPS set. This example embodiment recognizes that the arrival of a packet when the packet is subject to jitter typically has a mean and standard deviation in relation to the probability distribution that the jitter is determined by. For example in [3], jitter is modelled with a jitter window of 8 ms and a standard deviation of 2 ms. Using this embodiment, the SPS resource allocations within the standard deviation can be monitored more often than those outside of the standard deviation.

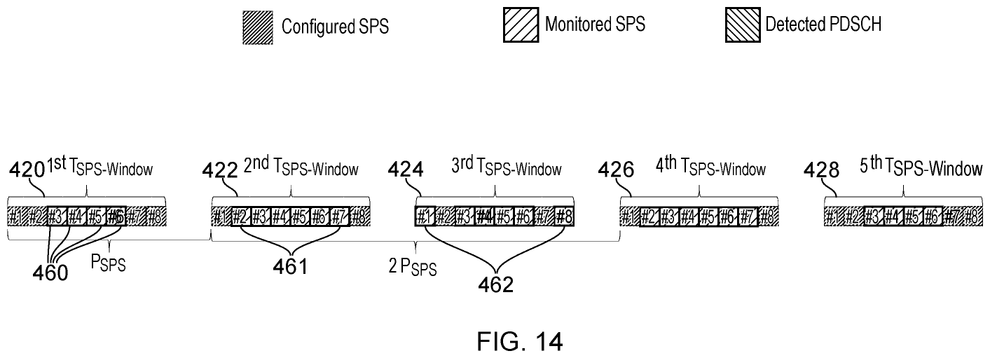

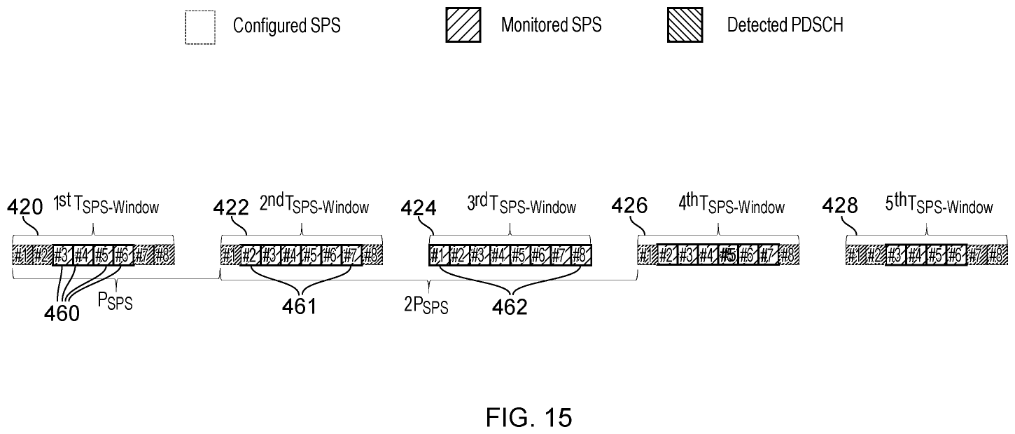

An example is represented by FIG. 14, where the SPS set contains eight SPS resource allocations numbered SPS #1 to SPS #8 and is divided into three SPS subsets. Subset #1={SPS #3, SPS #4, SPS #5, SPS #6}, 460, Subset #2={SPS #2, SPS #7}, 461, Subset #3={SPS #1, SPS #8}, 462. Subset #1 460 is monitored most frequently, as can be seen in FIG. 14 where the UE monitors this Subset #1 460 in each of the five time windows, with a periodicity of P_{SPS} between instances of monitoring. This is followed by Subset #2 461, which is monitored with a periodicity of 2P_{SPS}, in time windows 422 and 426. The subset monitored least frequently is Subset #3 462, which is monitored with a periodicity of 4P_{SPS}. This example configuration can be used for a jitter with 2 ms standard deviation and 8 ms jitter window as described in [3], where the packet is mostly likely to arrive in the middle of the jitter window and less likely at the outer sides of the window. Alternatively, as seen in FIG. 15, with regard to the same subsets and time windows, the UE can monitor first Subset #1 only in the first time window 420, then in the second time window 422 Subset #1 and Subset #2, in the third time window 424 all three subsets, Subset #1, Subset #2, and Subset #3, in the fourth time window 426 the UE could monitor only Subset #1 and Subset #2 again, and finally, in the fifth time window 428 the UE might monitor only Subset #1.

According to example embodiments, a UE is configured by the network to monitor subsets, which can be added and removed from a list of subsets of SPS resource allocations which the UE is monitoring in each time window. As is apparent, this can be altered on a time window level of granularity, in accordance with the gNB. It should also be appreciated that FIGS. 14 and 15 are just examples and other configurations are possible, e.g. the SPS resource allocations at the left hand side of the set of SPS resource allocations, N, for example SPS #1, SPS #2, and SPS #3, can be monitored more frequently than those at the right hand side of the SPS set N. Furthermore, each SPS subset may have its own SPS activation. For instance, SPS resource Subset #1 may be activated first. After a while, the gNB can activate Subset #2 and/or Subset #3, as will be explained further in later sections.

In another embodiment, the UE is configured to monitor the last M_{Last} SPS resource allocations in an SPS set. This embodiment is beneficial if the data packet arrives after the other monitored SPS resource allocations (as in the previous examples) and therefore allows the gNB an opportunity to delay the transmission of the data packet but still to transmit it to the UE within the time window.

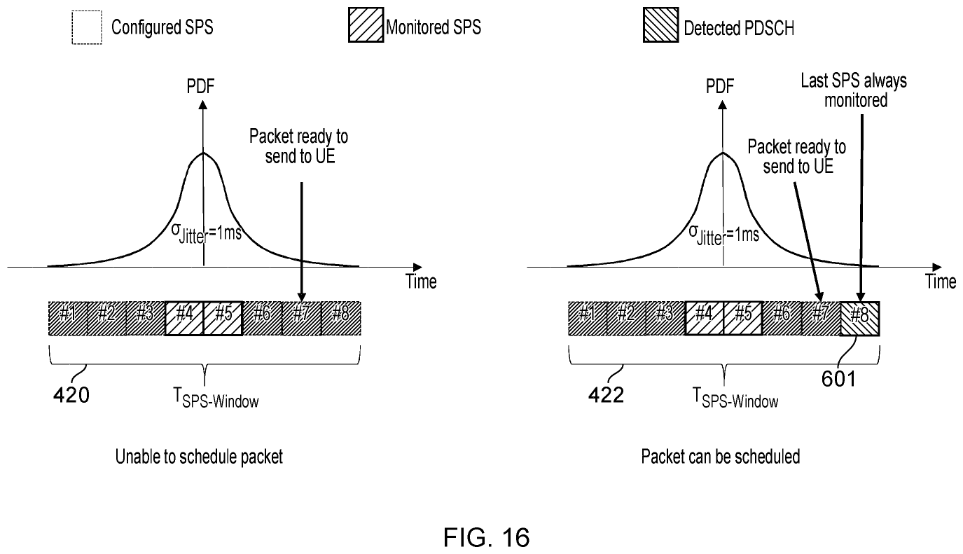

An example is shown in FIG. 16, where an SPS set contains eight SPS resource allocations numbered SPS #1-8. A probability distribution function is also represented, plotted with the value of the probability distribution function as a vertical axis, and time plotted as a horizontal axis. This represents the probability that the packet will arrive and be ready to send from the gNB to the UE at a particular time. The axis of time is common to both the left and right parts of the FIG. 16, such that the SPS resource allocations SPS #4 and SPS #5 are the resources corresponding to the highest values of the probability distribution function, and thus the highest probability of the packet being ready to send within the time corresponding to those resources. The expected traffic suffers from jitter with a mean centered on the middle of the respective time window and a standard deviation, σ_{Jitter}=1 ms. Accordingly, the UE is configured to monitor the resources to reflect the expected arrival time. Specifically, the UE is configured so that the central SPS resource allocations, SPS #4 and SPS #5, are monitored in each time window, with the other SPS resource allocations monitored less often, that is with a periodicity some multiple of the time window periodicity. FIG. 16 shows an instance of this on the left hand side in time window 420 where the central two SPS resource allocations are monitored but the data packet only becomes ready to send to the UE ahead of the penultimate SPS resource, SPS #7. Since the gNB knows that the UE is not monitoring either SPS #7 or SPS #8, the data packet will not be transmitted to the UE within the time window 420, because the gNB knows that the UE would be unable to receive and decode the data packet.

On the right hand side of FIG. 16, in time window 422, the last M_{LAST} SPS resource allocations 601 of the time window are always monitored, where in this example M_{LAST}=1. Therefore, in this example, the last SPS resource allocation of the time window is always monitored, SPS #8. When the data packet is ready to send to the UE in SPS #7, it can thus be delayed by a single SPS resource allocation, in this example, and transmitted in SPS #8 as the gNB knows that the UE will be monitoring the last SPS resource allocation. In this way, the PDSCH data packet can still be transmitted to the UE within the time window. It should be noted that although the example in FIG. 16 monitors only the last SPS resource allocation, i.e. the last M_{LAST}=1 SPS resource, this embodiment is applicable for more than one last SPS resource allocation, where, for instance M_{LAST}>1.

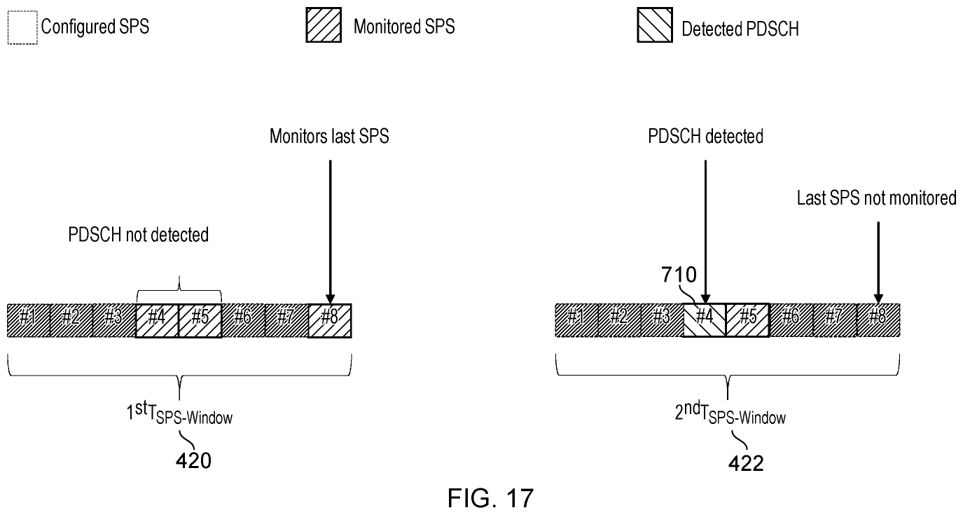

In another example embodiment, the UE monitors the last M_{LAST} SPS resource allocations in an SPS set if it detects fewer than M_{PDSCH} PDSCH data packets in the SPS set. In the previous example embodiment, the last M_{LAST} SPS resource allocations are final opportunities for the gNB to schedule a late arriving PDSCH data packet within the time window. However, this embodiment recognises that the M_{LAST} SPS resource allocations are unlikely to be utilised if the UE has already received the expected number of PDSCH data packets i.e. M_{PDSCH} data packets prior to the M_{LAST} SPS resource allocations. An example of this is shown in FIG. 17, where two time windows 420 and 422 are shown for an SPS set containing eight SPS resource allocations. In both time windows, the UE monitors SPS #4 and SPS #5. However, in this example, the value of M_{LAST}=1 and the value of M_{PDSCH}=1, so the UE monitors the last SPS resource allocation in the set, that is SPS #8, if it fails to detect the expected one PDSCH data packet in the previous SPS resource allocations it is scheduled to monitor.

In the first time window 420, the UE monitors SPS #4 and SPS #5 as described above, and fails to detect any PDSCH data packets therein, so monitors also the last resource, SPS #8. As indicated by the shading of the box, this last resource contains the PDSCH data packet. In the second time window 422, the UE is again scheduled to monitor the two central resources of the SPS set, SPS #4 and SPS #5, but in this example, the UE detects a PDSCH data packet in SPS #4 710, as indicated by the shading of the relevant box. It still monitors SPS #5 in this example, but, since it has detected the expected number of PDSCH data packets, M_{PDSCH}, in the SPS resource allocations it is scheduled to monitor, it does not monitor the final SPS resource allocation SPS #8.

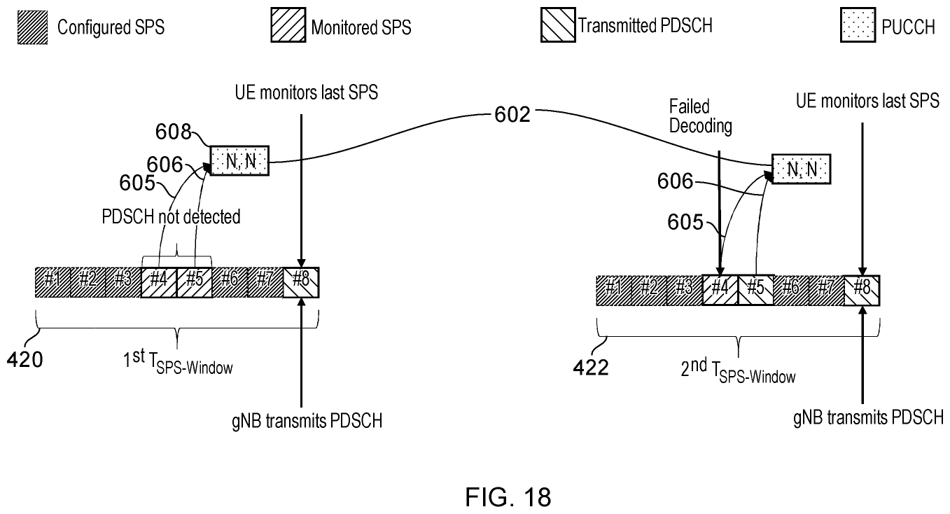

In another example embodiment, the UE monitors the last M_{LAST} SPS resource allocations in an SPS set if the UE feedbacks NACKs to the gNB with respect to the monitored SPS resource allocations in the SPS set. This embodiment recognises that the UE would feedback a NACK in response to a failure to detect a PDSCH data packet and in response to a failure to decode a PDSCH data packet. It also recognises that in some UE implementations, the UE may not be able to distinguish between a situation where it has failed to detect a PDSCH data packet and a situation where it has failed to decode a received PDSCH data packet. Since the gNB is aware of whether it has transmitted a PDSCH data packet in a specific SPS resource allocation, this embodiment enables the gNB to make use of an opportunity to transmit a PDSCH data packet to the UE even for the case of the UE failing to decode the PDSCH data packet, provided that the NACK which is carried on the PUCCH reaches the gNB prior to the last M_{LAST} SPS resource allocations. An example of this is shown in FIG. 18, where, as in previous example embodiments, the SPS set contains eight SPS resource allocations, and in the first time window 420 the UE monitors SPS #4 and SPS #5. Due to jitter, the packet is first ready to be transmitted to the UE after SPS #4 and SPS #5, and consequently the gNB is unable to transmit the PDSCH data packet to the UE using the monitored SPS #4 and SPS #5 resource allocations. Therefore, for example, the UE might, on failing to detect and decode any PDSCH data packet in SPS #4 and SPS #5, send HARQ-ACK feedback 608 via the PUCCH to the gNB, which in this case could be comprised of two NACKs, labelled {N,N} in FIG. 18. As would be understood from the previous embodiments, the UE can be provided with dedicated PUCCH HARQ-ACK feedback resources 602 in the PUCCH, according to the SPS resource allocations to which the feedback relates. This correspondence between the SPS resource allocations and relevant PUCCH HARQ-ACK resources is indicated by the arrows 605 and 606. In keeping with this embodiment, the UE monitors the last M_{LAST}=1 SPS resource, that is SPS #8, and the gNB delays the transmission of the PDSCH data packet to SPS #8 knowing that the UE will be monitoring it.

In the second time window, 422, the PDSCH data packet is transmitted to the UE in the fourth SPS resource SPS #4, but the UE fails to decode it, as indicated by the label. The failed decoding may result in a NACK feedback being sent to the gNB corresponding to SPS #4, and since no PDSCH data packet is transmitted from the gNB to the UE in SPS #5, this may also result in a NACK feedback being sent to the gNB, using the PUCCH resources 602. Having transmitted two NACK feedbacks, the UE then monitors the last SPS resource of the time window, SPS #8. Knowing that the UE will be monitoring this SPS resource, provided the PUCCH HARQ-ACK feedback arrives at the gNB before SPS #8, the gNB may then realise that the UE has failed to detect or decode the PDSCH data packet, and so repeat the transmission in the SPS #8 resource.

The value of M_{LAST} can be RRC configured, indicated in the activation DCI, fixed in the specifications, or indicated to the UE via another suitable technique. M_{LAST} can indicate a number, e.g. M_{LAST}=2 which indicates that the UE always monitors the last 2 SPS resource allocations in an SPS set, or M_{LAST} can indicate a set of SPS indexes. For instance, the gNB may have a configured SPS subset {SPS #8, SPS #3, SPS #4, SPS #7}, and M_{LAST} in this case may indicate M_{LAST}={SPS #4, SPS #7}.

### Combined Methods

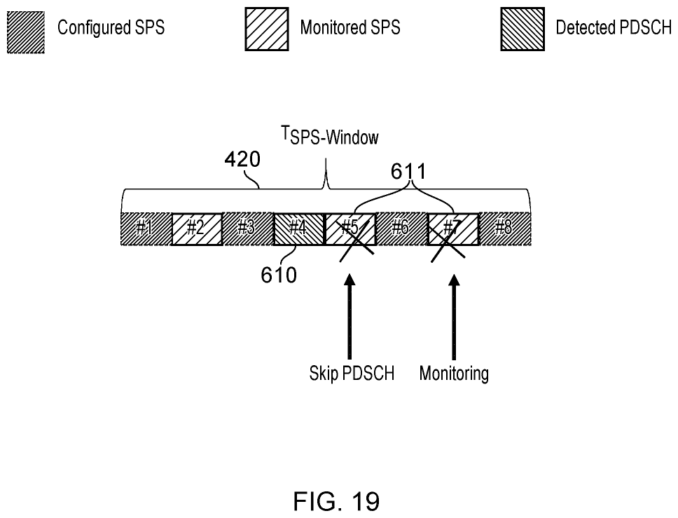

It should be appreciated that the previous example embodiments can be implemented individually or combined together. An example implementation is to divide the SPS set into multiple SPS subsets where each SPS subset has a different monitoring rate and in each time window instance, the UE will stop monitoring any further SPS if it detects M_{PDCSH} PDSCH data packets in the SPS set. An example is shown in FIG. 19, where the SPS set consists of eight SPS resource allocations and in a time window, the SPS subset containing {SPS #2, SPS #4, SPS #5, SPS #7} is to be monitored for PDSCH data packets by the UE as per a previous embodiment until one PDSCH data packet is received. In this example, the UE will stop monitoring any further SPS resource allocations in the monitored subset of SPS if it detects M_{PDSCH}=1 PDSCH data packet. In this example, the UE detects a PDSCH data packet in SPS #4 610 and consequently, it skips monitoring the remaining SPS resource allocations 611, i.e. SPS #5 and SPS #7, as indicated by the crosses in the Figure over SPS resource allocations SPS #5 and SPS #7.

### SPS Set

In accordance with the example embodiments described above and below with reference to FIGS. 12 to 20a, each configured SPS resource allocation can be associated with an SPS subset, and the associated SPS subset can be:
RRC Configured, e.g. under the SPS configuration with a new SPS subset parameter providing an index to the associated SPS subset
Dynamically indicated, e.g. in the activation DCI with a new SPS resource subset DCI field
Fixed in the specifications.

In another example embodiment, an SPS subset can be activated and deactivated by a DCI. In the legacy system, each SPS needs to be individually activated which can consume a large number of PDCCH resources. This embodiment allows a single DCI to activate all the SPS resource allocations in the SPS subset, which reduces PDCCH overheads.

In a separate embodiment, the SPS subset can be further configured into one or more SPS subsets. For example, an SPS subset={SPS #3, SPS #5, SPS #6, SPS #7} and the UE is configured with two SPS subsets, e.g. SPS subset #1={SPS #3, SPS #6} and SPS subset #2={SPS #5, SPS #7}. In a further example embodiment, an SPS subset in an SPS set can be activated and deactivated by a DCI.

### SPS Order

In the legacy method, an SPS resource index of an SPS resource allocation does not have any time order/relation with another SPS resource index. For example, an SPS resource with index eight, i.e. SPS #8 can be transmitted earlier than an SPS with index one, i.e. SPS #1. Hence, there is a need to provide a time order of the configured SPS resource allocations in an SPS set. An order of the SPS resource allocations in an SPS set may need to be indicated to the UE so that the UE knows which SPS resource allocation is the last in the SPS set, e.g. to implement the embodiments described in FIGS. 17 and 18.

In an example embodiment, an SPS Configuration Index, i.e. the RRC parameter sps-ConfigIndex, indicates the order of the SPS resource allocations in the SPS set. That is, if an SPS subset contains {SPS #2, SPS #7, SPS #8} then SPS #2 is the first SPS resource allocation, SPS #7 is the second SPS resource allocation and SPS #8 is the last SPS resource allocation in the SPS subset. In another embodiment, the order of the SPS resource allocations in an SPS subset is ordered according to when the SPS resource within the SPS subset is activated. Each SPS resource allocation is activated individually by an activation DCI and hence the earliest activated SPS resource allocation would be the first SPS resource allocation in the SPS subset, the next activated SPS resource allocation will be the second SPS resource allocation in the SPS subset and so on. In another embodiment, the order of the SPS resource allocations in an SPS subset is ordered according to their relative time position within the time window in which they exist. In another embodiment, the order of the SPS resource allocations in an SPS subset is RRC configured. That is, in addition to the SPS Set Index, each SPS resource allocation is further configured with the Order Index within the SPS Set Index.

In another embodiment, the offset of each SPS resource allocation in the SPS set can be RRC configured. In the legacy system, the offset is indicated individually in the TDRA DCI field in the activation DCI. This enables the implementation of the previous embodiment where a single activation DCI can activate all of the SPS resource allocations in an SPS subset. Here, the offset and order of each SPS resource allocation needs to be pre-configured. The activation DCI needs only to indicate the offset of the first SPS resource allocation in the SPS subset. The order of the SPS resource allocations in the SPS subset are sorted according to their offsets.

In another embodiment, the order of the SPS resource allocations in an SPS subset is indicated in the activation DCI. In another embodiment, the offset of each SPS resource in an SPS subset is indicated in the (single) activation DCI.

### Periodicity

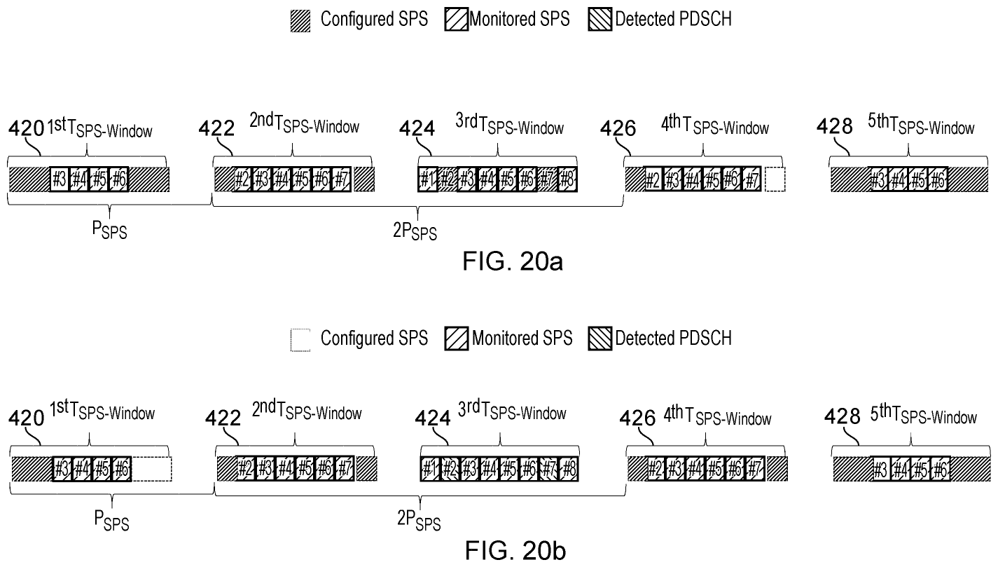

As is apparent from careful consideration of FIG. 14, although quasi-periodic traffic has a periodicity, e.g. P_{SPS} in FIG. 13 or P_{APP} in FIG. 11, the monitoring by the UE of different SPS resource allocations in an SPS subset does not necessarily have the same periodicity. This allows the embodiment in FIG. 14 to be implemented where subsets of the SPS resource allocations configured for the UE have different monitoring rates. Here different SPS subsets can be configured with different periodicities. An example is shown in FIG. 20a, where the set of SPS resource allocations {SPS #3, SPS #4, SPS #5, SPS #6} is configured with periodicity of P_{SPS} but with different offsets. Therefore, the resources are monitored by the UE in each of the five represented time windows 420-428. A second subset containing {SPS #2, SPS #7} is configured with periodicity of 2P_{SPS}, being monitored in two time windows 422 and 426, and a final subset containing {SPS #1, SPS #8} is configured with periodicity of 4P_{SPS}, and is thus monitored only once in the represented five time windows. This enables the different PDSCH monitoring embodiment to be implemented. FIG. 20b is a further example of an implementation of the different periodicity that different subsets of the SPS subset can have, and has similarities to FIG. 20a. The differences in this example are that the first subset is monitored in each of the five depicted time windows 420-428, and the second subset is monitored only in the second, third, and fourth time window 422, 424, 426 depicted in the Figure. Furthermore, the third subset is monitored only in the third time window 424. This is an example of the flexibility of the system, and particularly of the gNB, to control the monitoring of SPS resource allocations by the UE.

Although the legacy system allows for different periodicity for each SPS subset and hence the configuration in FIGS. 20a and 20b can be achieved using legacy configurations, the UE still needs the SPS subset association so that it knows the order of the SPS resource allocations.

### UE Capability

A UE may indicate the maximum number of configured SPS resource allocations in a SPS set that it is able to monitor, the number of SPS subsets in an SPS set that it can support, and the number of active SPS resource allocations in an SPS set. A UE may also indicate its capability in terms of SPS resource activation, for example one or the combination of the following:
The UE requires activation for each configured SPS resource allocation
The UE requires activation for each SPS subset
The UE requires activation for each SPS set

It will be appreciated that references to “time resource unit” may be any unit of communications resources in the time domain. For example, a time resource unit may be a slot or sub-slot as will be appreciated by one skilled in the art.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A communications device, for receiving data from a wireless communications network, the communications device comprising
receiver circuitry, configured to receive data from the wireless communications network via the wireless access interface,
transmitter circuitry, configured to transmit wireless communications to the wireless
communications network via the wireless access interface, and controller circuitry configured to control the receiver circuitry
to receive an indication of a subset of SPS resource allocations for each of one or more of a plurality of sets of SPS resource allocations of the wireless access interface for receiving the data as data packets, which should be monitored for receiving one or more of the data packets, the subset to be monitored in each set of SPS resource allocations being less than or equal to a total number of SPS resource allocations in the set, and
to monitor the subset of the SPS resource allocations for each of the sets to receive one or more downlink data packets which may be transmitted in one or more of the SPS resource allocations of the subset of the SPS resource allocations to receive the data.

Paragraph 2. A communications device according to paragraph 1, wherein the controller circuitry is configured to control the receiver circuitry to receive the one or more downlink data packets in the subset of the SPS resource allocations, and the controller circuitry is configured to control the receiver circuitry
to receive an indicated number, M_{PDSCH}, of an expected number of data packets to be received.

Paragraph 3. A communications device according to paragraph 2, wherein the controller circuitry is configured to control the receiver circuitry
for each of the sets of the SPS resource allocations to stop monitoring SPS resource allocations in the subset of the one of more SPS resources elements after the indicated number M_{PDSCH} of the one or more data packets have been received.

Paragraph 4. A communications device according to any of paragraphs 1, 2 or 3, wherein the indication of the subset of SPS resource allocations for each of the one or more sets of SPS resource allocations for receiving the data packets indicates one or more different subsets of SPS resource allocations for a plurality of sets of SPS resource allocations of the wireless access interface for receiving the data packets, and a plurality of monitoring periodicities corresponding to the plurality of subsets of SPS resource allocations, and
to monitor each of the plurality of subsets of SPS resource allocations in accordance with the received monitoring periodicity corresponding to the subset of SPS resource allocations.

Paragraph 5. A communications device according to any of paragraphs 1 to 4, wherein the indication of the subset of SPS resource allocations for each of the one or more sets of SPS resource allocations for receiving the data packets indicates for each subset a pattern of the SPS resource allocations of the set to be monitored.

Paragraph 6. A communications device according to paragraph 5, wherein one or more of the resource allocations of one or more of the subsets are separated by one or more resource allocations which are not monitored, the resource allocations not being in the subset.

Paragraph 7. A communications device according to any of paragraphs 5 or 6, wherein the pattern of the resource allocations of the subset of SPS resource allocations indicated includes a number, M_{LAST}, of last one or more SPS resource allocations, the number of the last one or more SPS resource allocations to be monitored being a latest in time of the set of SPS resource allocations.

Paragraph 8. A communications device according to paragraphs 2 to 6, wherein the controller circuitry is configured to control the receiver circuitry to monitor a final number M_{PDSCH} of one or more SPS resource allocations of the set of SPS resource allocations to receive one or more data packets if the receiver circuitry does not receive the expected number of data packets within the subset of the SPS resource allocations that the receiver circuitry is to monitor.

Paragraph 9. A communications device according to paragraphs 2 to 6, wherein the controller circuitry is configured to control the receiver circuitry to receive an indication that if the receiver circuitry does not receive the expected number of data packets within the subset of the SPS resource allocations that the receiver circuitry is to monitor, the receiver circuitry is to monitor a final number M_{PDSCH} of one or more SPS resource allocations of the set of SPS resource allocations.

Paragraph 10. A communications device according to paragraph 8 or 9, wherein the number of final SPS resource allocations of the set of SPS resource allocations monitored is determined from a difference between the expected number of data packets and the one or more data packets received by the receiver circuitry.

Paragraph 11. A communications device according to paragraph 2, wherein the controller circuitry is configured to control the receiver circuitry to receive an indication of uplink resource allocations for the transmission of HARQ-ACK type feedback to the wireless communications network,
to determine, based on the monitoring of the subset of the SPS resource allocations, whether the receiver circuitry has received the expected one or more data packets in the subset of the SPS resource allocations,
to control the transmitter circuitry to transmit, in response to determining that the receiver circuitry has not received the expected one or more data packets in the subset of the SPS resource allocations, HARQ-ACK type feedback to the wireless communications network to provide an indication that the receiver circuitry has not received the expected one or more data packets in the subset of the SPS resource allocations.

Paragraph 12. A communications device according to paragraph 11, wherein the controller circuitry is configured to control the receiver circuitry, in response to the transmitter circuitry transmitting HARQ-ACK type feedback to the wireless communications network to provide an indication that the receiver circuitry has not detected or decoded the expected one or more data packets in the subset of the SPS resource allocations, to monitor the final SPS resource allocation in the set of SPS resource allocations.

Paragraph 13. A communications device according to paragraph 12, wherein the controller circuitry is configured to control the receiver circuitry, in response to the transmitter circuitry transmitting HARQ-ACK type feedback to the wireless communications network to provide an indication that the receiver circuitry has not received the expected one or more data packets in the subset of the SPS resource allocations, to monitor one or more SPS resource allocations in the set of SPS resource allocations,
wherein, a number of the one or more SPS resource allocations in the set of SPS resource allocations is a difference between the expected one or more data packets and the received number of data packets, and
the one or more SPS resource allocations that the receiver circuitry is controlled to monitor are the final one or more SPS resource allocations of the set of SPS resource allocations.

Paragraph 14. A communications device according to any of paragraphs 1 to 13, wherein the communications device is a low power device, a machine type communications device or a reduced capability device.

Paragraph 15. A communications device according to any of paragraphs 1 to 14, wherein the controller circuitry is configured with the receiver circuitry
to receive an activation indicator to activate the plurality of sets of SPS resource allocations of the wireless access interface indicating that the wireless communications network will transmit one or more data packets in the sub-set of SPS resource allocations for the set of SPS resource allocations.

Paragraph 16. A communications device according to any of paragraphs 1 to 14, wherein the controller circuitry is configured with the receiver circuitry
to receive a deactivation for each of one or more of the plurality of sets of SPS resource allocations of the wireless access interface indicating that the wireless communications network will not transmit one or more data packets in the sub-set of SPS resource allocations for the set of SPS resource allocations.

Paragraph 17. A method of operating a communications device to receive data from a wireless communications network, the method comprising
receiving an indication of a subset of SPS resource allocations for each of one or more of a plurality of sets of SPS resource allocations of the wireless access interface for receiving the data as data packets, which should be monitored for receiving one or more of the data packets, the subset to be monitored in each set of SPS resource allocations being less than or equal to a total number of SPS resource allocations in the set, and
monitoring the subset of the SPS resource allocations for each of the sets to receive one or more downlink data packets which may be transmitted in one or more of the SPS resource allocations of the subset of the SPS resource allocations to receive the data.

Paragraph 18. A method according to paragraph 17, wherein the receiving the one or more downlink data packets in the subset of the SPS resource allocations includes receiving an indicated number, M_{PDSCH}, of an expected number of data packets to be received.

Paragraph 19. A method according to paragraph 18, wherein the receiving the one or more downlink data packets in the subset of the SPS resource allocations includes determining, for each of the sets of the SPS resource allocations, that the indicated number M_{PDSCH} of the one or more data packets have been received, stopping the monitoring of the SPS resource allocations in the subset of the one of more SPS resources elements after the indicated number M_{PDSCH} of the one or more data packets have been received.

Paragraph 20. A method according to any of paragraphs 17, 18 or 19, wherein the received indication of the subset of SPS resource allocations for each of the one or more sets of SPS resource allocations for receiving the data packets indicates one or more different subsets of SPS resource allocations for a plurality of sets of SPS resource allocations of the wireless access interface for receiving the data packets, and a plurality of monitoring periodicities corresponding to the plurality of subsets of SPS resource allocations, and the monitoring the subset of the SPS resource allocations for each of the sets to receive one or more downlink data packets comprises
monitoring each of the plurality of subsets of SPS resource allocations in accordance with the received monitoring periodicity corresponding to the subset of SPS resource allocations.

Paragraph 21. A method according to any of paragraphs 17 to 20, wherein the indication of the subset of SPS resource allocations for each of the one or more sets of SPS resource allocations for receiving the data packets indicates for each subset a pattern of the SPS resource allocations of the set to be monitored.

Paragraph 22. A method according to paragraph 21, wherein one or more of the resource allocations of one or more of the subsets are separated by one or more resource allocations which are not monitored, the resource allocations not being in the subset.

Paragraph 23. A method according to any of paragraphs 21 or 22, wherein the pattern of the resource allocations of the subset of SPS resource allocations indicated includes a number, M_{LAST}, of last one or more SPS resource allocations, the number of the last one or more SPS resource allocations to be monitored being a latest in time of the set of SPS resource allocations.

Paragraph 24. A method according to paragraphs 18 to 23, wherein the monitoring the subset of the SPS resource allocations for each of the sets to receive one or more downlink data packets comprises
monitoring a final number M_{PDSCH} of one or more SPS resource allocations of the set of SPS resource allocations to receive one or more data packets if the receiver circuitry does not receive the expected number of data packets within the subset of the SPS resource allocations that the receiver circuitry is to monitor.

Paragraph 25. A method according to paragraphs 18 to 23, comprising receiving an indication that if the receiver circuitry does not receive the expected number of data packets within the subset of the SPS resource allocations, the monitoring the subset of the SPS resource allocations for each of the sets to receive one or more downlink data packets should include monitoring a final number M_{PDSCH} of one or more SPS resource allocations of the set of SPS resource allocations.

Paragraph 26. A method according to paragraph 24 or 25, wherein the number of final SPS resource allocations of the set of SPS resource allocations monitored is determined from a difference between the expected number of data packets and the one or more data packets received by the receiver circuitry.

Paragraph 27. A method according to paragraph 18, comprising
receiving an indication of uplink resource allocations for the transmission of HARQ-ACK type feedback to the wireless communications network,
determining, based on the monitoring of the subset of the SPS resource allocations, whether the receiver circuitry has received the expected one or more data packets in the subset of the SPS resource allocations, and
in response to determining that the receiver circuitry has not received the expected one or more data packets in the subset of the SPS resource allocations, transmitting HARQ-ACK type feedback to the wireless communications network to provide an indication that the receiver circuitry has not received the expected one or more data packets in the subset of the SPS resource allocations.

Paragraph 28. A method according to paragraph 27, wherein in response to determining that the expected number of one or more data packets has not received in the subset of the SPS resource allocations, monitoring the final SPS resource allocation in the set of SPS resource allocations.

Paragraph 29. A method according to paragraph 27, wherein in response to determining that the expected number of one or more data packets has not received in the subset of the SPS resource allocations, monitoring one or more SPS resource allocations in the set of SPS resource allocations,
wherein, a number of the one or more SPS resource allocations in the set of SPS resource allocations is a difference between the expected one or more data packets and the received number of data packets, and the one or more SPS resource allocations monitored are the final one or more SPS resource allocations of the set of SPS resource allocations.

Paragraph 30. A method according to any of paragraphs 17 to 29, wherein the communications device is a low power device, a machine type communications device or a reduced capability device.

Paragraph 31. A method according to any of paragraphs 17 to 30, comprising receiving an activation indicator to activate the plurality of sets of SPS resource allocations of the wireless access interface indicating that the wireless communications network will transmit one or more data packets in the sub-set of SPS resource allocations for the set of SPS resource allocations.

Paragraph 32. A method according to any of paragraphs 17 to 30, comprising
receiving a deactivation for each of one or more of the plurality of sets of SPS resource allocations of the wireless access interface indicating that the wireless communications network will not transmit one or more data packets in the sub-set of SPS resource allocations for the set of SPS resource allocations.

Paragraph 33. An infrastructure equipment forming part of a wireless communications network for communicating with one or more a communications devices, the infrastructure equipment comprising
receiver circuitry, configured to receive wireless communications from the one or more communications devices via a wireless access interface,
transmitter circuitry, configured to transmit data to the one or more communications devices via the wireless access interface,
controller circuitry configured to control the transmitter circuitry
to transmit, to one of the communications devices, an indication of a subset of SPS resource allocations for each of one or more of a plurality of sets of SPS resource allocations of the wireless access interface for transmitting the data as data packets, which should be monitored by the communications device for receiving one or more of the data packets, the subset to be monitored in each set of SPS resource allocations being less than or equal to a total number of SPS resource allocations in the set, and
to transmit to the communications device the one or more data packets, via the wireless access interface using the subset of SPS resource allocations.

Paragraph 34. An infrastructure equipment according to paragraph 33, wherein the controller circuitry is configured to control the transmitter circuitry to transmit an indicated number, M_{PDSCH}, of an expected number of data packets to be received.

Paragraph 35. An infrastructure equipment according to any of paragraphs 33 or 34, wherein the indication of the subset of SPS resource allocations for each of the one or more sets of SPS resource allocations for receiving the data packets indicates one or more different subsets of SPS resource allocations for a plurality of sets of SPS resource allocations of the wireless access interface for receiving the data packets, and a plurality of monitoring periodicities corresponding to the plurality of subsets of SPS resource allocations.

Paragraph 36. An infrastructure equipment according to any of paragraphs 33 to 35, wherein the indication of the subset of SPS resource allocations for each of the one or more sets of SPS resource allocations for receiving the data packets indicates for each subset a pattern of the SPS resource allocations of the set to be monitored.

Paragraph 37. An infrastructure equipment according to paragraph 36, wherein one or more of the resource allocations of one or more of the subsets are separated by one or more resource allocations which are not monitored, the resource allocations not being in the subset.

Paragraph 38. An infrastructure equipment according to any of paragraphs 36 or 37, wherein the pattern of the resource allocations of the subset of SPS resource allocations indicated includes a number, M_{LAST}, of last one or more SPS resource allocations, the number of the last one or more SPS resource allocations to be monitored being a latest in time of the set of SPS resource allocations.

Paragraph 39. An infrastructure equipment according to paragraphs 34 to 38, wherein the controller circuitry is configured to control the transmitter circuitry to transmit an indication that if the communications device does not receive the expected number of data packets within the subset of the SPS resource allocations that the communications device should monitor a final number M_{PDSCH} of one or more SPS resource allocations of the set of SPS resource allocations.

Paragraph 40. An infrastructure equipment according to paragraph 34, wherein the controller circuitry is configured to control the transmitter circuitry to transmit an indication of uplink resource allocations for the transmission of HARQ-ACK type feedback to the wireless communications network, and the controller circuitry is configured to control the receiver circuitry to receive a HARQ-ACK type feedback indicating whether or not the communications device has received the expected number of one or more data packets in the subset of the SPS resource allocations.

Paragraph 41. An infrastructure equipment according to paragraph 40, wherein the controller circuitry is configured to control the transmitter circuitry to transmit an indication that if the communications device has not detected the expected one or more data packets in the subset of the SPS resource allocations then the communications device should monitor the final SPS resource allocation in the set of SPS resource allocations.

Paragraph 42. An infrastructure equipment according to paragraph 40, wherein the controller circuitry is configured to control the transmitter circuitry to transmit an indication that if the communications device has not detected the expected one or more data packets in the subset of the SPS resource allocations then the communications device should monitor one or more SPS resource allocations in the set of SPS resource allocations,
wherein, a number of the one or more SPS resource allocations in the set of SPS resource allocations is a difference between the expected one or more data packets and the received number of data packets, and
the one or more SPS resource allocations that the communications device should monitor are the final one or more SPS resource allocations of the set of SPS resource allocations.

Paragraph 43. An infrastructure equipment according to any of paragraphs 33 to 42, wherein the controller circuitry is configured with the transmitter circuitry
to transmit an activation indicator to activate the plurality of sets of SPS resource allocations of the wireless access interface indicating that the wireless communications network will transmit one or more data packets in the sub-set of SPS resource allocations for the set of SPS resource allocations.

Paragraph 44. An infrastructure equipment according to any of paragraphs 33 to 42, wherein the controller circuitry is configured with the transmitter circuitry
to transmit a deactivation for each of one or more of the plurality of sets of SPS resource allocations of the wireless access interface indicating that the wireless communications network will not transmit one or more data packets in the sub-set of SPS resource allocations for the set of SPS resource allocations.

Paragraph 45. A method by an infrastructure equipment forming part of a wireless communications network for communicating with one or more communications devices, the method comprising
transmitting, to one of the communications devices, an indication of a subset of SPS resource allocations for each of one or more of a plurality of sets of SPS resource allocations of the wireless access interface for transmitting the data as data packets, which should be monitored by the communications device for receiving one or more of the data packets, the subset to be monitored in each set of SPS resource allocations being less than or equal to a total number of SPS resource allocations in the set, and
transmitting to the communications device the one or more data packets, via the wireless access interface using the subset of SPS resource allocations.

Paragraph 46. A method according to paragraph 45, comprising transmitting an indicated number, M_{PDSCH}, of an expected number of data packets to be received.

Paragraph 47. A method according to any of paragraphs 45 or 46, wherein the indication of the subset of SPS resource allocations for each of the one or more sets of SPS resource allocations for receiving the data packets indicates one or more different subsets of SPS resource allocations for a plurality of sets of

SPS resource allocations of the wireless access interface for receiving the data packets, and a plurality of monitoring periodicities corresponding to the plurality of subsets of SPS resource allocations.

Paragraph 48. A method according to any of paragraphs 45 to 47, wherein the indication of the subset of SPS resource allocations for each of the one or more sets of SPS resource allocations for receiving the data packets indicates for each subset a pattern of the SPS resource allocations of the set to be monitored.

Paragraph 49. A method according to paragraph 48, wherein one or more of the resource allocations of one or more of the subsets are separated by one or more resource allocations which are not monitored, the resource allocations not being in the subset.

Paragraph 50. A method according to any of paragraphs 48 or 49, wherein the pattern of the resource allocations of the subset of SPS resource allocations indicated includes a number, M_{LAST}, of last one or more SPS resource allocations, the number of the last one or more SPS resource allocations to be monitored being a latest in time of the set of SPS resource allocations.

Paragraph 51. A method according to paragraphs 46 to 50, comprising transmitting an indication that if the communications device does not receive the expected number of data packets within the subset of the SPS resource allocations that the communications device should monitor a final number M_{PDSCH} of one or more SPS resource allocations of the set of SPS resource allocations.

Paragraph 52. A method according to paragraph 51, comprising transmitting an indication of uplink resource allocations for the transmission of HARQ-ACK type feedback to the wireless communications network, and the controller circuitry is configured to control the receiver circuitry to receive a HARQ-ACK type feedback indicating whether or not the communications device has received the expected number of one or more data packets in the subset of the SPS resource allocations.

Paragraph 53. A method according to paragraph 52, comprising transmitting an indication that if the communications device has not detected the expected one or more data packets in the subset of the SPS resource allocations then the communications device should monitor the final SPS resource allocation in the set of SPS resource allocations.

Paragraph 54. A method according to paragraph 52, comprising transmitting an indication that if the communications device has not detected the expected one or more data packets in the subset of the SPS resource allocations then the communications device should monitor one or more SPS resource allocations in the set of SPS resource allocations,
wherein, a number of the one or more SPS resource allocations in the set of SPS resource allocations is a difference between the expected one or more data packets and the received number of data packets, and
the one or more SPS resource allocations that the communications device should monitor are the final one or more SPS resource allocations of the set of SPS resource allocations.

Paragraph 55. A method according to any of paragraphs 45 to 54, comprising transmitting an activation for each of one or more of the plurality of sets of SPS resource allocations of the wireless access interface indicating that the wireless communications network will transmit one or more data packets in the sub-set of SPS resource allocations for the set of SPS resource allocations.

Paragraph 56. A method according to any of paragraphs 45 to 55, comprising transmitting a deactivation for each of one or more of the plurality of sets of SPS resource allocations of the wireless access interface indicating that the wireless communications network will not transmit one or more data packets in the sub-set of SPS resource allocations for the set of SPS resource allocations.

Paragraph 57. A telecommunications system comprising a communications device according to any of paragraphs 1 to 16 and an infrastructure equipment according to any one of paragraphs 33 to 44.

Paragraph 58. A computer program comprising instructions which, when loaded onto a computer, cause the computer to perform a method according to any one of paragraphs 17 to 32 or paragraphs 45 to 56.

Paragraph 59. A non-transitory computer-readable storage medium storing a computer program according to paragraph 58.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-213587, “New SID: Study on XR Enhancements for NR”, Nokia, RAN #94e
[3] TR38.838, “Study on XR (Extended Reality) Evaluations for NR (Release 17)”, v17.0.0

1. A communications device, for receiving data from a wireless communications network, the communications device comprising
receiver circuitry, configured to receive data from the wireless communications network via the wireless access interface,
transmitter circuitry, configured to transmit wireless communications to the wireless communications network via the wireless access interface, and
controller circuitry configured to control the receiver circuitry
to receive an indication of a subset of SPS resource allocations for each of one or more of a plurality of sets of SPS resource allocations of the wireless access interface for receiving the data as data packets, which should be monitored for receiving one or more of the data packets, the subset to be monitored in each set of SPS resource allocations being less than or equal to a total number of SPS resource allocations in the set, and
to monitor the subset of the SPS resource allocations for each of the sets to receive one or more downlink data packets which may be transmitted in one or more of the SPS resource allocations of the subset of the SPS resource allocations to receive the data.

2. A communications device according to claim 1, wherein the controller circuitry is configured to control the receiver circuitry to receive the one or more downlink data packets in the subset of the SPS resource allocations, and the controller circuitry is configured to control the receiver circuitry
to receive an indicated number, M_{PDSCH}, of an expected number of data packets to be received.

3. A communications device according to claim 2, wherein the controller circuitry is configured to control the receiver circuitry
for each of the sets of the SPS resource allocations to stop monitoring SPS resource allocations in the subset of the one of more SPS resources elements after the indicated number M_{PDSCH} of the one or more data packets have been received.

4. A communications device according to claim 1, wherein the indication of the subset of SPS resource allocations for each of the one or more sets of SPS resource allocations for receiving the data packets indicates one or more different subsets of SPS resource allocations for a plurality of sets of SPS resource allocations of the wireless access interface for receiving the data packets, and a plurality of monitoring periodicities corresponding to the plurality of subsets of SPS resource allocations, and
to monitor each of the plurality of subsets of SPS resource allocations in accordance with the received monitoring periodicity corresponding to the subset of SPS resource allocations.

5. A communications device according to claim 1, wherein the indication of the subset of SPS resource allocations for each of the one or more sets of SPS resource allocations for receiving the data packets indicates for each subset a pattern of the SPS resource allocations of the set to be monitored.

6. A communications device according to claim 5, wherein one or more of the resource allocations of one or more of the subsets are separated by one or more resource allocations which are not monitored, the resource allocations not being in the subset.

7. A communications device according to claim 5, wherein the pattern of the resource allocations of the subset of SPS resource allocations indicated includes a number, M_{LAST}, of last one or more SPS resource allocations, the number of the last one or more SPS resource allocations to be monitored being a latest in time of the set of SPS resource allocations.

8. A communications device according to claim 2, wherein the controller circuitry is configured to control the receiver circuitry to monitor a final number M_{PDSCH} of one or more SPS resource allocations of the set of SPS resource allocations to receive one or more data packets if the receiver circuitry does not receive the expected number of data packets within the subset of the SPS resource allocations that the receiver circuitry is to monitor.

9. A communications device according to claim 2, wherein the controller circuitry is configured to control the receiver circuitry to receive an indication that if the receiver circuitry does not receive the expected number of data packets within the subset of the SPS resource allocations that the receiver circuitry is to monitor, the receiver circuitry is to monitor a final number M_{PDSCH} of one or more SPS resource allocations of the set of SPS resource allocations.

10. A communications device according to claim 8, wherein the number of final SPS resource allocations of the set of SPS resource allocations monitored is determined from a difference between the expected number of data packets and the one or more data packets received by the receiver circuitry.

11. A communications device according to claim 2, wherein the controller circuitry is configured to control the receiver circuitry to receive an indication of uplink resource allocations for the transmission of HARQ-ACK type feedback to the wireless communications network,
to determine, based on the monitoring of the subset of the SPS resource allocations, whether the receiver circuitry has received the expected one or more data packets in the subset of the SPS resource allocations,
to control the transmitter circuitry to transmit, in response to determining that the receiver circuitry has not received the expected one or more data packets in the subset of the SPS resource allocations, HARQ-ACK type feedback to the wireless communications network to provide an indication that the receiver circuitry has not received the expected one or more data packets in the subset of the SPS resource allocations.

12. A communications device according to claim 11, wherein the controller circuitry is configured to control the receiver circuitry, in response to the transmitter circuitry transmitting HARQ-ACK type feedback to the wireless communications network to provide an indication that the receiver circuitry has not detected or decoded the expected one or more data packets in the subset of the SPS resource allocations, to monitor the final SPS resource allocation in the set of SPS resource allocations.

13. A communications device according to claim 12, wherein the controller circuitry is configured to control the receiver circuitry, in response to the transmitter circuitry transmitting HARQ-ACK type feedback to the wireless communications network to provide an indication that the receiver circuitry has not received the expected one or more data packets in the subset of the SPS resource allocations, to monitor one or more SPS resource allocations in the set of SPS resource allocations,
wherein, a number of the one or more SPS resource allocations in the set of SPS resource allocations is a difference between the expected one or more data packets and the received number of data packets, and
the one or more SPS resource allocations that the receiver circuitry is controlled to monitor are the final one or more SPS resource allocations of the set of SPS resource allocations.

14. A communications device according to claim 1, wherein the communications device is a low power device, a machine type communications device or a reduced capability device.

15. A communications device according to claim 1, wherein the controller circuitry is configured with the receiver circuitry
to receive an activation indicator to activate the plurality of sets of SPS resource allocations of the wireless access interface indicating that the wireless communications network will transmit one or more data packets in the sub-set of SPS resource allocations for the set of SPS resource allocations.

16. A communications device according to claim 1, wherein the controller circuitry is configured with the receiver circuitry
to receive a deactivation for each of one or more of the plurality of sets of SPS resource allocations of the wireless access interface indicating that the wireless communications network will not transmit one or more data packets in the sub-set of SPS resource allocations for the set of SPS resource allocations.

17.-32. (canceled)

33. An infrastructure equipment forming part of a wireless communications network for communicating with one or more a communications devices, the infrastructure equipment comprising
receiver circuitry, configured to receive wireless communications from the one or more communications devices via a wireless access interface,
transmitter circuitry, configured to transmit data to the one or more communications devices via the wireless access interface,
controller circuitry configured to control the transmitter circuitry
to transmit, to one of the communications devices, an indication of a subset of SPS resource allocations for each of one or more of a plurality of sets of SPS resource allocations of the wireless access interface for transmitting the data as data packets, which should be monitored by the communications device for receiving one or more of the data packets, the subset to be monitored in each set of SPS resource allocations being less than or equal to a total number of SPS resource allocations in the set, and
to transmit to the communications device the one or more data packets, via the wireless access interface using the subset of SPS resource allocations.

34. An infrastructure equipment according to claim 33, wherein the controller circuitry is configured to control the transmitter circuitry to transmit an indicated number, M_{PDSCH}, of an expected number of data packets to be received.

35. An infrastructure equipment according to claim 33, wherein the indication of the subset of SPS resource allocations for each of the one or more sets of SPS resource allocations for receiving the data packets indicates one or more different subsets of SPS resource allocations for a plurality of sets of SPS resource allocations of the wireless access interface for receiving the data packets, and a plurality of monitoring periodicities corresponding to the plurality of subsets of SPS resource allocations.

36. An infrastructure equipment according to claim 33, wherein the indication of the subset of SPS resource allocations for each of the one or more sets of SPS resource allocations for receiving the data packets indicates for each subset a pattern of the SPS resource allocations of the set to be monitored.

37.-59. (canceled)
